(19) United States
(12) Patent Application Publication
(10) Pub. No.: US 2023/0401514 A1
(43) Pub. Date: Dec. 14, 2023

(54) HYBRID SYSTEMS AND METHODS FOR IDENTIFYING CAUSE-EFFECT RELATIONSHIPS IN STRUCTURED DATA

(71) Applicant: Narrative BI, Inc., Middletown, DE (US)

(72) Inventors: Mikhail Rumiantsau, San Francisco, CA (US); Yury Koleda, Minsk (BY); Aliaksei Vertsei, Redwood City, CA (US)

(73) Assignee: Narrative BI, Inc., Middletown, DE (US)

(21) Appl. No.: 18/455,899

(22) Filed: Aug. 25, 2023

Related U.S. Application Data
(63) Continuation-in-part of application No. 17/880,331, filed on Aug. 3, 2022.
(60) Provisional application No. 63/228,719, filed on Aug. 3, 2021.

(51) Int. Cl. G06Q 10/0637; G06Q 10/067; G06Q 10/0639

(52) U.S. Cl. CPC G06Q 10/06375; G06Q 10/067; G06Q 10/06393

(57) ABSTRACT

Systems and methods are described for automatically identifying cause-effect relationships using hybrid systems. A server may retrieve selected expert rule templates that have input parameters that match the parameters of event data objects derived from a stream of input data. Cause-effect relationships may be determined between parameters of the data set when the selected expert rule templates are satisfied. The rule-based aspect is augmented using statistical correlation to identify a correlated pair of different parameters based on pairwise comparison of all parameters of a data set and a coincidence probability of the different parameters. Using the identified correlated pair, the server may create a new expert rule template in an expert rule database. Subsequent data in the stream of input data may trigger generating an alert when one of the expert rule templates is contradicted by the incoming data, thereby ensuring that the expert rule templates are up-to-date and accurate.

### CROSS-REFERENCE TO RELATED APPLICATIONS

This application is a continuation-in-part of U.S. application Ser. No. 17/880,331, filed Aug. 3, 2022, which claims the benefit of U.S. Provisional Patent Application No. 63/228,719, filed Aug. 3, 2021, the entire contents of both are incorporated herein by reference.

### TECHNICAL FIELD

This disclosure relates generally to the technical field of computer-implemented methods for linking data sets with visualizations. Specifically, the disclosure describes linking dynamic rules, which may be automatically generated, from a database to data sets received over a network connection to identify cause-effect relationships and automatically generate insight visualizations.

### SUMMARY OF THE INVENTION

Systems and methods are described for automatically identifying cause-effect relationships using hybrid systems. A server may extract event data objects from a stream of input data received over a network connection, each event data object including a parameter from a data set and a numerical trend over a predetermined period of time. The server may then, via a rule engine module, retrieve a plurality of selected expert rule templates from an expert rule database based on having input parameters that match the parameters of one or more of the event data objects. Each expert rule template stored within the expert rule database may include a cause parameter from the data set, an effect parameter from the data set, change thresholds for both the cause and the effect parameters and time intervals for both the cause and effect parameters. The server may then identify cause-effect relationships between parameters of the data set in response to the selected expert rule templates being satisfied by the extracted event data objects. Based on the identified cause-effect relationships, narrative text and one or more visualizations associated with a satisfied selected expert rule template may be transmitted over the network connection to a display device and displayed on an insight graphic interface.

The rule-based system is augmented by a statistical correlation module (hence rendering the overall system to be a hybrid system), which the server uses to identify a correlated pair of different parameters of the data set observed over a plurality of predetermined correlation time periods. The correlated pair may be identified based on pairwise comparison of all parameters of the data set and a coincidence probability of the different parameters. Based on the identified correlated pair, the server may create a new expert rule template in the expert rule database. Furthermore, subsequent data in the stream of input data may trigger generating an alert when one of the expert rule templates in the expert rule database or the new expert rule template is contradicted by the incoming data, thereby ensuring that the expert rule templates are up-to-date and accurate for the data set.

### BRIEF DESCRIPTION OF THE FIGURES

This disclosure is illustrated by way of example and not limitation in the figures of the accompanying drawings, in which like references indicate similar elements, and in which:

FIG. 1 is a block diagram illustrating an example operating environment for deriving and applying insight templates to received data sets, according to one or more embodiments of the disclosure.

FIG. 2 is a flow diagram illustrating an example method of generating and displaying an insight graphic interface according to one or more embodiments of the disclosure.

FIG. 3 is a block diagram of a virtual company model linking data sources and performance indicators according to one or more embodiments of the disclosure.

FIG. 4 is a block diagram illustrating data mapping using data sets formatted using preexisting data templates according to one or more embodiments of the disclosure.

FIG. 5 is a block diagram illustrating an exemplary insight data structure according to one or more embodiments of the disclosure.

FIGS. 6A-D show exemplary insight templates according to one or more embodiments of the disclosure.

FIG. 7 is a screenshot illustrating configurable settings for a insight template according to one or more embodiments of the disclosure.

FIG. 8 is a flow diagram illustrating an example method of utilizing user feedback for insight templates according to one or more embodiments of the disclosure.

FIG. 9 is a screenshot illustrating an insight graphic interface according to one or more embodiments of the disclosure.

FIG. 10 is a block diagram illustrating an example computing system that may be used in conjunction with one or more embodiments of the disclosure.

FIG. 11 is a block diagram illustrating an example operating environment for automatically identifying cause-effect relationships using hybrid systems, according to one or more embodiments of the disclosure.

FIG. 12 is a flow diagram illustrating an example method of using a hybrid system to identify cause-effect relationships in a data set using historical and a stream of subsequent input data, according to one or more embodiments of the disclosure.

FIG. 13 is a flow diagram illustrating an example method of using an expert rule template-based approach to identifying cause-effect relationships of a data set, according to one or more embodiments of the disclosure.

FIG. 14 is a flow diagram illustrating an example method of using statistical correlation approach to generate and modify rule templates, according to one or more embodiments of the disclosure.

FIGS. 15A-B show exemplary interfaces showing insight graphic interfaces associated with a satisfied selected expert rule template according to one or more embodiments of the disclosure.

FIGS. 16A-C show exemplary interfaces showing insight graphic interfaces associated with satisfied selected expert rule templates having common cause parameters according to one or more embodiments of the disclosure.

### DETAILED DESCRIPTION

Legacy business intelligence (“BI”) systems and dashboards are descriptive: they require further interpretation by a data-savvy professional. Actionable Insights described herein may track past decisions, plan actions, and mark events on the timeline for adoption (by providing relevant insights and/or actionable recommendations). Businesses may have several very similar parts (e.g. marketing, sales, salaries, taxes, expenses) and as a result very similar key performance indicators (KPIs) for these metrics. A high-level virtual model of a business may allow business users to see as many KPIs as possible depending on the amount of input data and mapping of input data to virtual model inputs. As a result, generated insights may be based on real business KPIs and can be converted to recommendations presented on a graphic user interface.

Methods and systems for users to generate actionable recommendations for insight using internal virtual company model (VCM) and actionable templates for specific company states for specific or general verticals are described herein. The data set may be tagged, and then mapped to a set of performance indicator expressions. Key performance indicators (KPIs) may be determined based on the mapped data set. Using the mapped data set, a virtual company model may then be generated, where the virtual company model is a graph with data sources (variables) acting as root nodes and performance indicators on leaf nodes. Once the system calculates all available KPIs—all the results together are stored as a company performance snapshot. These snapshots are used to match actionable recommendation templates against them.

Subsequently, a database of actionable insight templates may be accessed, where each template contains multiple rules which apply restrictions on the current company performance snapshot. Specific templates may be selected from the database based on the specific templates matching data in the performance snapshot by a matching module. The specific templates may then be applied to the mapped data set to automatically generate one or more actionable insight interfaces. The actionable insight interfaces may be displayed on a display of a computer system, where each actionable insight interface includes one or more recommendations derived from the application of the specific templates to the mapped data set.

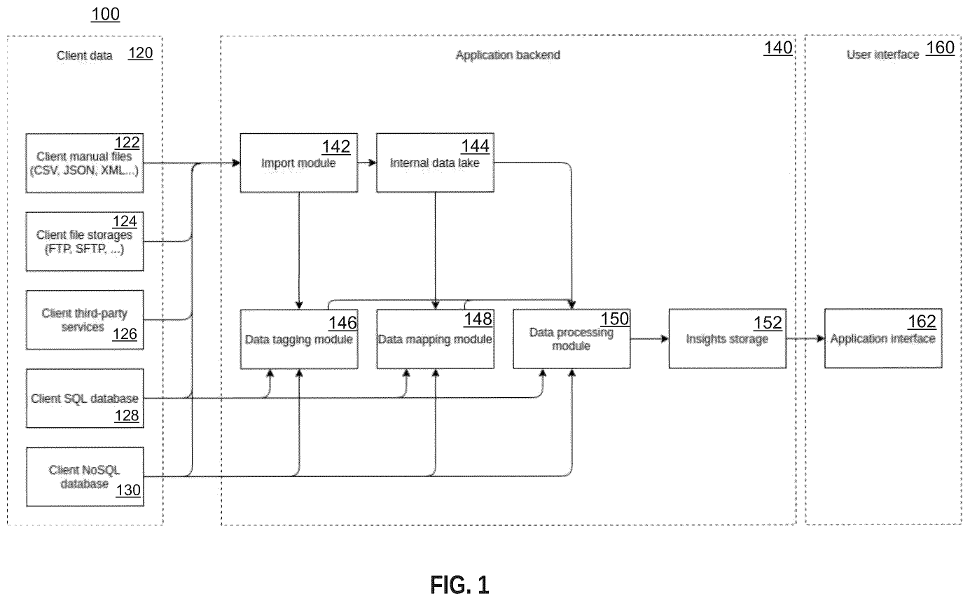

More specifically, and with reference to FIG. 1, shown is a block diagram illustrating an example of an operating environment 100 for deriving and applying insight templates to received data sets, according to one or more embodiments of the disclosure. As shown, the operating environment 100 may include a client system 120, an application back end 140, and a user interface 160. It should be noted that the components of operating environment 100 may interact via network connections, which may be any type of wired or wireless network including a local area network (LAN), a wide area network (WAN), or a direct communication link, or other suitable connection.

The communications network used by elements 120, 140, and 160 to communicate may itself be comprised of many interconnected computer systems and communication links. The communications links may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, the communication network is the Internet, in other embodiments, the communication network may be any suitable communication network including a local area network (LAN), a wide area network (WAN), a wireless network, a intranet, a private network, a public network, a switched network, and combinations of these, and the like.

Client data systems 120 may include client manual files 122, client file storages 124, third party data storage services 126, SQL databases 128, and/or non-SQL databases 130. The application backend 140 may include import module 142 to retrieve data from the client data sources 120. The import module 142 may be communicatively coupled to internal data lake 144 and data tagging module 146, whose operation is described in greater detail below. The tagging module 146 and data lake 144 may operate together with data mapping module 148 and data processing module 150 to generate a tagged and mapped version of a data set received from one or more of the client data sources 120. The output tagged and mapped data set may be then matched to various insight templates stored in insights storage 152 to generate an insight graphical interface, which may be transmit to the application interface 162 of the user interface 160.

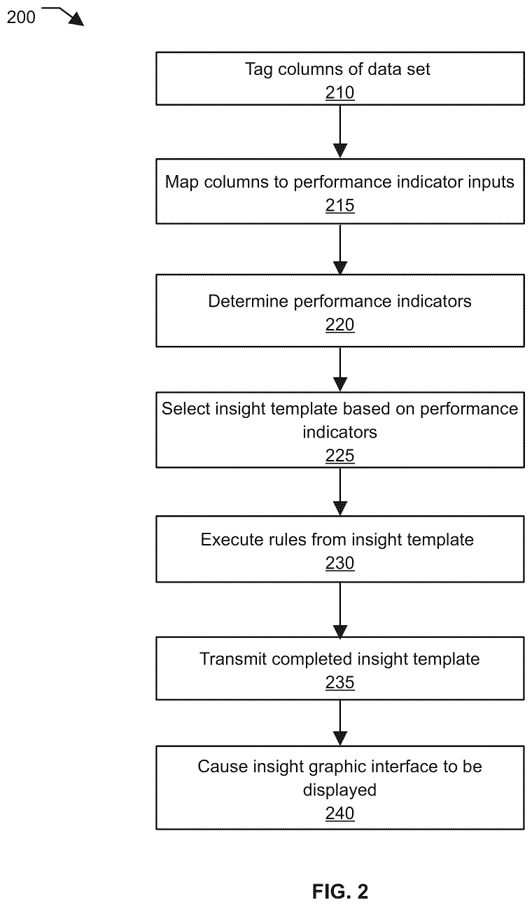

FIG. 2 is a flow diagram illustrating an example method 200 of generating and displaying an insight graphic interface according to one or more embodiments of the disclosure. Process 200 may use processing logic, which may include software, hardware, or a combination thereof. For example, process 200 may be performed by a system including one or more components described in operating environment 100.

In block 210, a server (e.g. application backend 140) may tag data columns of a data set, which is received from a client device (e.g. one of client data sources 120) over a network connection. The data tagging system allows each data column to be associated with specific data types and dimensional/categorical data. The dimensional/categorical data may be used for data interpretation by various internal algorithms. Examples of data columns with their data types and dimensions are listed below:

{
″datatype[CLIENT_NAME/tasks/_id]″: ″id″,
″property[CLIENT_NAME/tasks/ id]″:
″dimension″, ″datatype[CLIENT_NAME/courses/_id]″: ″id″,
″property[CLIENT_NAME/courses/_id]″: ″dimension″,
″datatype[CLIENT_NAME/payments/price]″: ″numerical″,
″datatype[CLIENT_NAME/tasks/title.en]″: ″categorical″,
″datatype[CLIENT_NAME/tasks/title.ru]″: ″categorical″,
″property[CLIENT_NAME/payments/price]″: ″metric″,
″property[CLIENT_NAME/tasks/title.en]″: ″dimension″
″property[CLIENT_NAME/tasks/title.ru]″: ″dimension″,
″datatype[CLIENT_NAME/courses/name.en]″: ″categorical″,
″datatype[CLIENT_NAME/courses/name.ru]″: ″categorical″,
″datatype[CLIENT_NAME/payments/userID]″: ″id″,
″property[CLIENT_NAME/courses/name.en]″: ″dimension″,
″property[CLIENT_NAME/courses/name.ru]″: ″dimension″,
″property[CLIENT_NAME/payments/userID]″: ″dimension″,
″datatype[CLIENT_NAME/payments/created]″: ″datetime″,
″property[CLIENT_NAME/payments/created]″: ″dimension″
}

The tagged data columns may be then mapped to a plurality of performance indicator inputs at block 215. The data mapping system may map any kind of client's data to the corresponding system inputs (variables) and lets the system calculate KPIs based on such variables. Each variable can be represented by several data columns. In that case, the system decides which data column should be used for specific KPI calculations depending on other variables involved in the calculation. An example of the commands that may be used to implement the mapping:

{
″columns[USER_ID]″: [ ″CLIENT_NAME/payments/userID″],
″columns[ORDER_DATE]″: [ ″CLIENT_NAME/payments/created″],
″columns[ORDER_VALUE]″: [ ″CLIENT_NAME/payments/price″]
}

In case a variable is represented by multiple columns, the system may perform the calculation in several steps:
Compose a full set of columns which represent all required variables for KPI calculation.
Select a subset of columns which represent all required variables and can be used for calculation. The system may search for the first available condition:
Select a subset of columns which belong to the same table;
Select a subset of columns which belong to joinable tables (we know that from the source data structure);
Select a subset of columns which belong to the same source and can be correlated by timeframe (we know that from the source data structure);
Select a subset of columns which can be correlated by timeframe (we know that from the multiple sources data structures);
Skip calculation if none available.
Run the calculation against available subset of columns.

The system may need to perform some additional processing of the tagged data depending on the identified data types: (1) format conversion and (2) value normalization. (1) Format conversion is needed in most cases since data sources may use various formats, e.g. it's most obvious for date and time presentation, which can be presented as YYYY-MM-DD, Year/Month/Day, Year/Day/Month, etc. Another example is boolean data type which can be presented in a data set as “true/false”, “yes/no”, “1/0”, “+/−” etc. (2) Another step of data type processing is value normalization. An example of such processing could be normalization of categorical data types, e.g. a product category can be presented as “clothes”, “apparel”, “garment” and a specific synonym map will be needed if a certain KPI mapping formula (e.g. total sales by category) requires the system to group all objects of such category in one bucket.

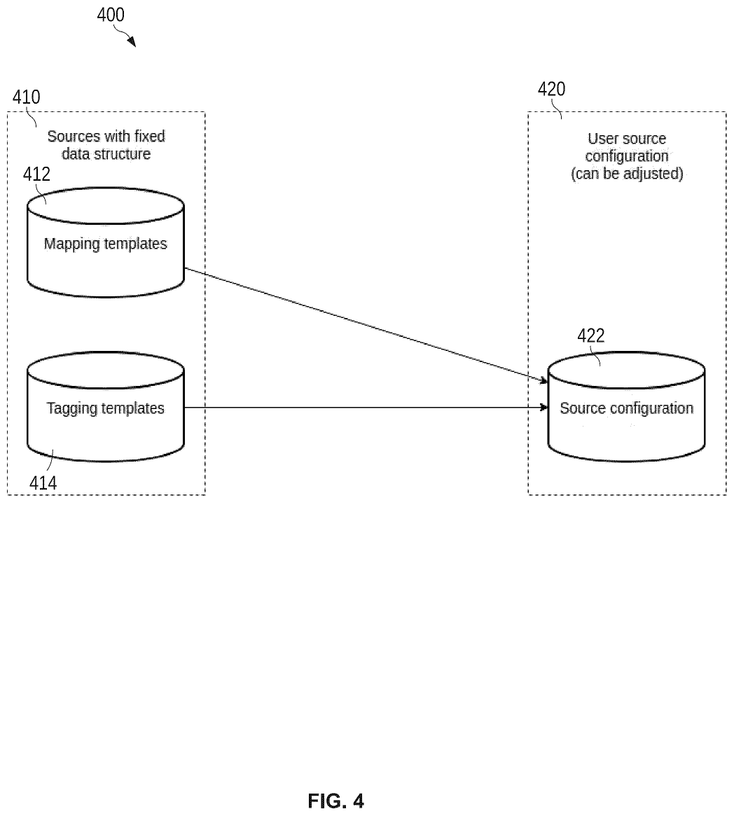

In some embodiments, predetermined mapping and tagging templates may be used for client data sources with fixed (or at least partially fixed) data structures (e.g. Google® Analytics, developed by Google Inc. of Mountain View, California). This is shown in FIG. 4, a block diagram 400 illustrating data mapping using data sets formatted using preexisting data templates according to one or more embodiments of the disclosure. In case a client adds a data source 410 which has appropriate mapping templates 412 and tagging configuration templates 414, these templates will be copied directly to the user's source configuration 420. These templates provide basic and general configuration. Any specific user's data source configuration 422 can be changed anytime to meet the user's needs.

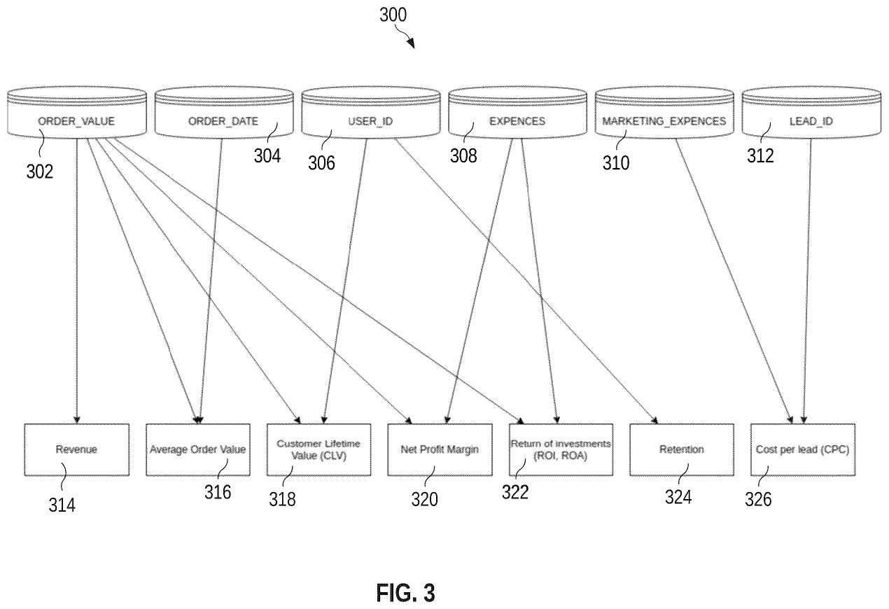

After the mapping has taken place, a plurality of performance indicators may be determined from the performance indicator inputs at block 220. In an embodiment, using the mapped data set, a virtual company model may then be generated, where the virtual company model is a graph with data sources (variables) acting as root nodes and performance indicators on leaf nodes. FIG. 3 is a block diagram of a virtual company model 300 linking data sources and performance indicators according to one or more embodiments of the disclosure. As seen in model 300, the data sources 302, 304, 306, 308, 310, and 312 are root nodes linked to associated performance indicators 314, 316, 318, 320, 322, 324, and 326. Once the system calculates all available KPIs—all the results together are stored as a company performance snapshot. These snapshots are used to match actionable recommendation templates against them. Incoming connections for a node mean that specific KPI might be calculated only if all the incoming connections are fulfilled (system has required data for all root elements).

KPIs are used to calculate a company's performance by different metrics. The described system uses general formulas to calculate KPIs (similar to pseudo code), and substitutes formula parameters depending on various factors (user request, current time frame, amount of data, etc.). Once the system calculates all available KPIs—all the results together are stored as a company performance snapshot. These snapshots are used to match actionable recommendation templates against them. Table 1 below displays various performance indicators and exemplary code that may be used to determine the performance indicators.

TABLE 1
List of exemplary KPI determination formula

| KPI (Metric) | Pseudo code |
|---|---|
| Average Order Value | avg(ORDER_VALUE) per ORDER_DATE |
| Bounce rate | BOUNCE_RATE per BOUNCE_DATE |
| Customer Lifetime Value (CLV) | avg(ORDER_VALUE) per USER_ID |
| Net Profit Margin | sum(ORDER_VALUE) − sum(EXPENCES) |
| Return of investments (ROI, ROA) | (sum(ORDER_VALUE) − sum(EXPENCES))/sum(EXPENCES) |
| Retention | count(DISTINCT USER_ID period N) - count(USER_ID in |
| | LIST_USER_ID period N − 1)/count(DISTINCT USER_ID perion |
| | N − 1) |
| Revenue | sum(ORDER_VALUE) |
| Cost per lead (CPC) | sum(MARKETING_EXPENCES)/count(DISTINCT LEAD_ID) |
| Conversion rate (funnel) | sum(LEVEL = N)/sum(LEVEL = N + 1) |
| Average Sales Cycle Length | count(UNIQUE ORDER_DATE)/sum(BOOL Flag deal) |
| Click through rate (CTR) | CTR per CTR_DATE |
| Cost of Customer Acquisition (CAC) | sum(EXPENCES)/count(DISTINCT USER_ID) |
| Lead Response Time | sum(LEAD_ANSWER_DATE-LEAD_START_DATE)/ |
| | count(DISTINCT LEAD_ID) |
| Response rate | avg(BOOL Flag answered calls) |
| Revenue per customer | sum(ORDER_VALUE)/count(DISTINCT USER_ID) |
| Revenue per FTE | sum(ORDER_VALUE)/count(DISTINCT EMPLOYEE_ID) |
| Customer Return Rate | avg(BOOL Flag rejected goods) |
| Acid-Test Ratio | (sum(CASH) + sum(MARKETABLE_SECURITIES) + |
| | sum(ACCOUNTS_RECEIVABLE))/sum(LIABILITIES) |
| Avoided Cost | sum(ASSUMED_REPAIR_COST) + |
| | sum(PRODUCTION_LOSSES) − sum(PREVENTION_COST) |
| Capacity Utilization | sum(PRODUCED_GOODS)/sum(MAX_PRODUCTION_PLAN) |
| Customer Satisfaction Score (CSAT) | avg(BOOL Flag customer_mark IN [4,5]) per USER_ID |
| Debt To Equity Ratio | sum(LIABILITIES)/sum(EQUITY) |
| Dormancy Rate | avg(BOOL Flag LAST_VISIT_DATE is not NULL) per USER_ID |
| Employee Absence Rate | avg(BOOL Flag STATUS = ABSENT) per EMPLOYEE_ID |
| Employee Turnover Rate | avg(BOOL Flag STATUS = LEFT) per EMPLOYEE_ID |
| First Pass Yield (FPY) | avg(BOOL QUALITY_CONTROLL) |
| First Response Time (FRT) | sum(MIN(TICKET_ANSWER_DATE)-TICKET_START_DATE)/ |
| | count(DISTINCT TICKET_ID) |
| Free Cash Flow (FCF) | sum(EBIT) + sum (DEPRECIATION) + sum(TAXES) - |
| | (sum(WORKING CAPITAL period N + 1) − sum(WORKING |
| | CAPITAL period N)) − sum(CAPITAL_EXPEDITURES) |
| Levered Cash Flow (LCF) | sum(EBITDA) + sum (DEPRECIATION) - (sum(WORKING |
| | CAPITAL period N + 1) − sum(WORKING CAPITAL period N)) − |
| | sum(CAPITAL_EXPEDITURES) − sum(DEBT_PAYMENTS) |
| Net Present Value (NPV) | sum(CASH_EXPECTED)/sum(CASH_INVESTED) |
| Net Promoter Score (NPS) | (count(QUESTION_WILL_YOU_ADVICE_APP_FREIEND = YES) - |
| | count(QUESTION_WILL_YOU_ADVICE_APP_FREIEND = NO))/ |
| | count(QUESTION_WILL_YOU_ADVICE_APP_FREIEND IS NOT |
| | NULL) |
| On-Time Delivery | avg(BOOL Flag IS_DELAYED) |
| Operating Cash Flow | sum(EBIT) + sum (DEPRECIATION) + sum(TAXES) - |
| | (sum(WORKING CAPITAL period N + 1) − sum(WORKING |
| | CAPITAL period N)) |
| Payroll Headcount Ratio | avg(BOOL Flag POSITION_TYPE = FULL_TIME) per |
| | EMPLOYEE_ID |
| Return on assets | (sum(ORDER_VALUE) − sum(NET_COST))/sum(ASSETS) |
| Return on Equity (ROE) | (sum(ORDER_VALUE) − sum(EXPENCES))/ |
| | sum(STACKEHOLDERS EQUITY) |
| Working Capital Ratio | sum(ASSETS)/sum(LIABILITIES) |

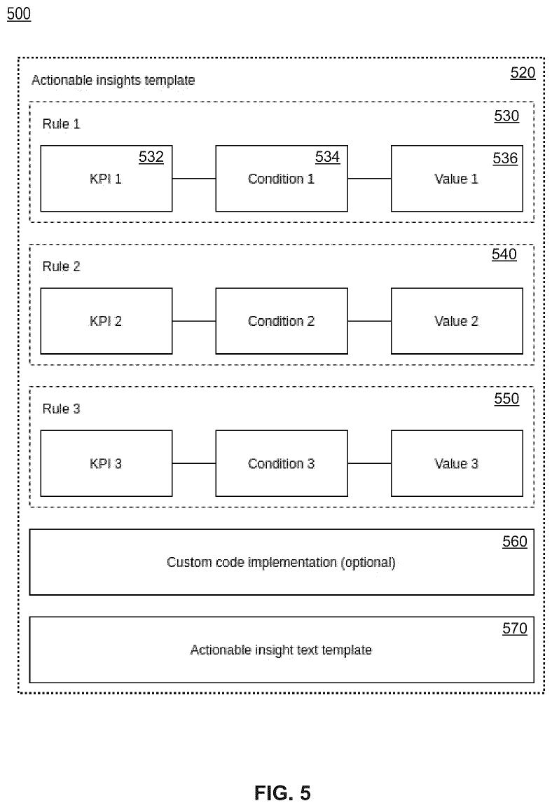

A selected insight template may then be retrieved, by the server, from a plurality of insight templates stored within a template database at block 225. The retrieved insight template may be selected based on the determined performance indicators matching input requirements of the selected insight template. FIG. 5 is a block diagram 500 illustrating an exemplary insight data structure according to one or more embodiments of the disclosure. Each insight template 520 stored within the template database may be stored as a data object that includes a plurality of rules 530, 540, and 550. Each template may include multiple rules which apply restrictions on the current company performance snapshot. Rules may be defined as simple restrictions (logical operators with fixed values).

Each rule may receive one or more performance indicators 532 as inputs and derive a rule output 536 from the received performance indicators using a condition 534. The data object of each insight template may also include narrative text 570 that provides a text recommendation based on the rule outputs (such as rule output value 536). Actionable insight text templates 570 may contain text which supports variable interpolation. Variables may be calculated by the custom code 560 or be taken directly from the company performance snapshot (e.g., using specific KPIs). In some embodiments, a custom code implementation 560 may be included, for example, to derive one or more visualizations based on the rule outputs from rules 530, 540, and 550. Custom code 560 may also be used for complex calculations (e.g. specific values in actionable insight text or custom complex rules). Some exemplary insight templates might contain no rules, and may only evaluate custom code to generate actionable insights.

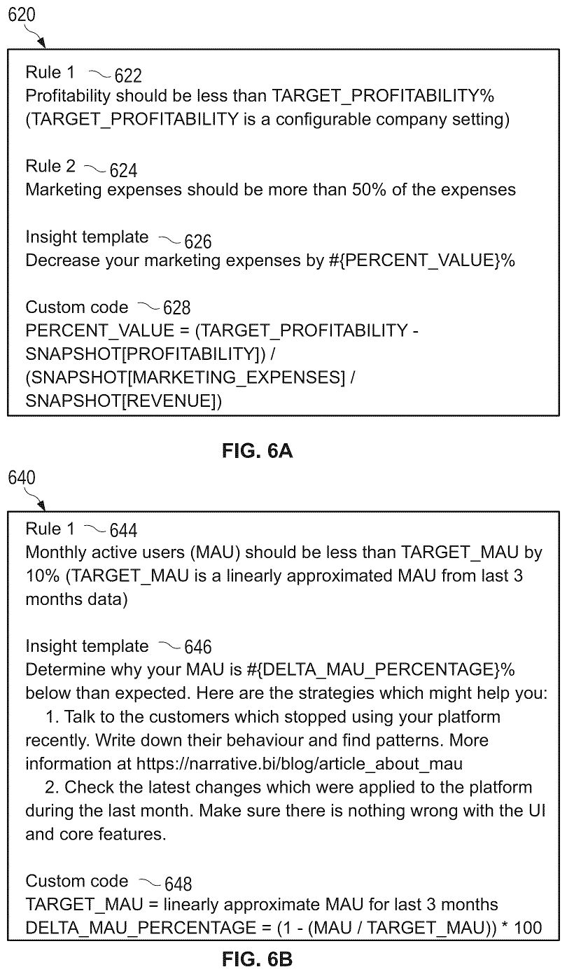

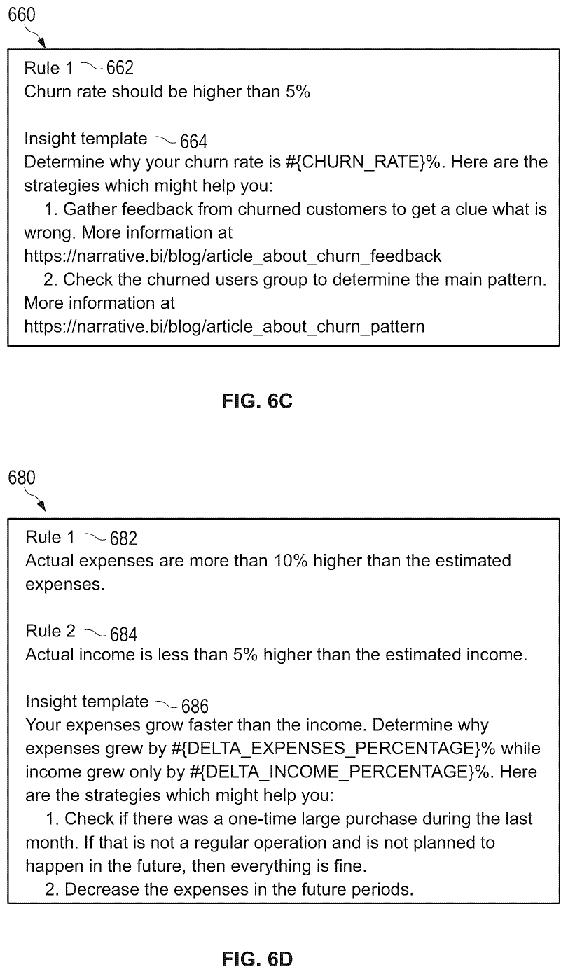

FIGS. 6A-D show exemplary insight templates 620, 640, 660, and 680 according to one or more embodiments of the disclosure. Each template, which may be stored within a template database, includes one or more rules 622, 624, 644, 662, 682, and 684, and narrative text in the form of insight templates 626, 646, 664, and 686. Some of the insight templates shown include custom code 628 and 648, used for more complex determinations.

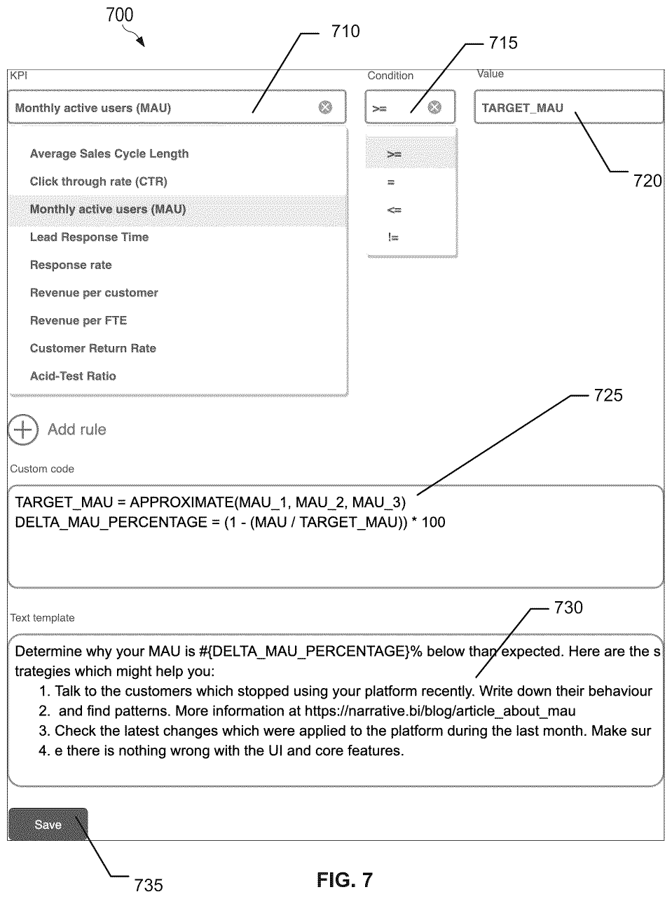

When a new client data source is added, the information about the source and data structure inside that source may be used to create a list of KPIs (metrics) which can be calculated using the data from the new source. After that, a user may compose another list of actionable insights which can be created using available KPIs and data. These specific insights may be added to an actionable insights template database by, for example, using an insight template form. FIG. 7 is a screenshot 700 illustrating configurable settings for an insight template according to one or more embodiments of the disclosure. As shown in screenshot 700, the insight template intake form may include selectable options for performance indicators 710, the condition for a rule 715, and the rule output name 720. Input areas for custom code 725 and narrative text 730 may also be included. Once a user has finished inputting at least one rule and the narrative text for the new insight template, the insight template may be saved to the template database by the user selecting save button 735.

In an exemplary embodiment, the system may select only applicable actionable insight templates by vertical and time frame. Some insights might not have a specific vertical; in that case they are matched to any vertical. As a second step, the system matches all applicable actionable insight templates against the current company performance snapshot. If all template conditions are satisfied, the recommendation will be generated and added to the insight automatically.

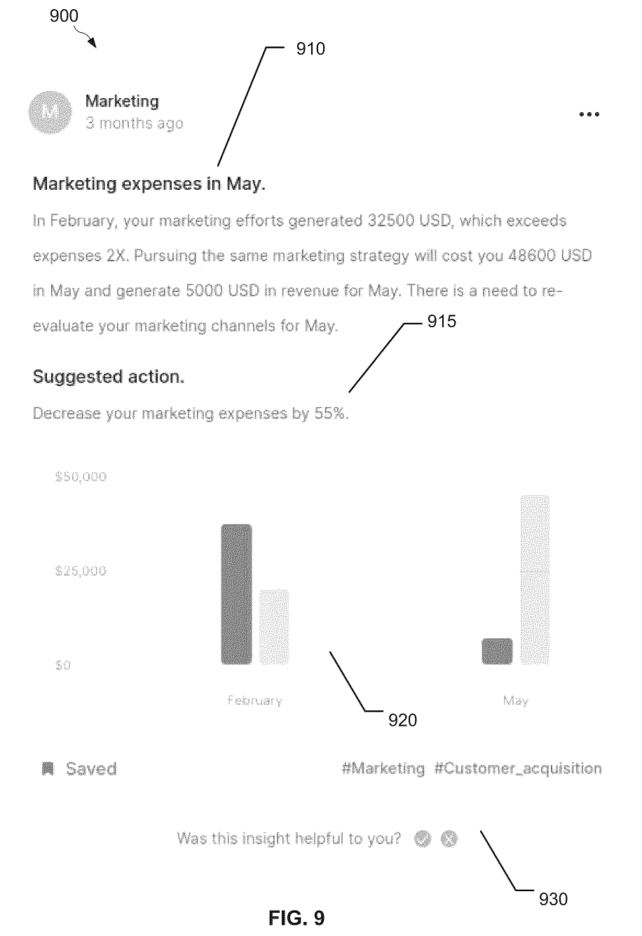

Returning to method 200, the server may then execute the rules included within the selected insight template at block 230 using the determined plurality of performance indicators for the received data set. After the rules have been executed, the server may transmit, via the network connection, the narrative text and the rule outputs to a display device (such as user interface 160) at block 235. The server may then cause an insight graphic interface to be displayed by the display device, where the insight graphic interface includes the text recommendation, at block 240. FIG. 9 is a screenshot 900 illustrating an insight graphic interface according to one or more embodiments of the disclosure. The exemplary insight graphic interface may include the narrative text 910 complete with any values included in the narrative text. A recommendation 915 is also included as part of the narrative text recommending what actions the user can take to improve the performance indicators. Exemplary insight graphic interface 900 also includes visualization 920 derived from the performance indicators. Finally, feedback features 930 allow a user to provide feedback, which may be used as input to method 800, for example.

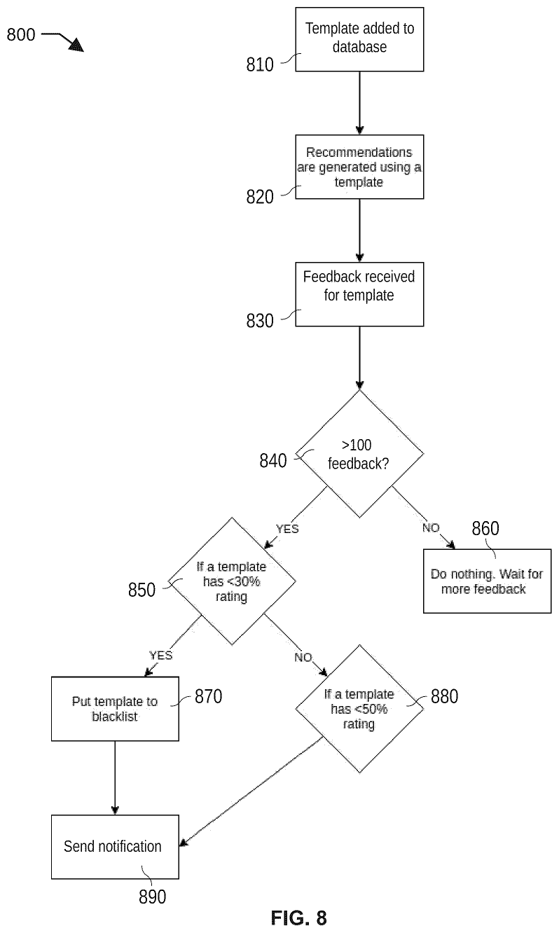

Some embodiments of the present invention may also allow the user the system to configure which types of actionable insights should be displayed or hidden in the output of the system. Depending on the specific business setup, certain KPIs might appear to be more or less important in the decision making process, therefore allowing the user to mark those KPIs as important or not important may provide additional value and make the system more usable. FIG. 8 is a flow diagram illustrating an example method of utilizing user feedback for insight templates according to one or more embodiments of the disclosure. After a insight template is added to the database at block 810, a recommendation template may be generated for the insight template at block 820. The template may allow users to provide feedback on the quality and business value of the generated insights, e.g. by adding “like” and “dislike” buttons in the user interface associated with the recommendation template. At block 840, the amount of feedback may be tallied for the insight template and compared to a threshold (e.g. 100 in the exemplary embodiment). When there is fewer than the threshold amount of feedback received, no action is taken at block 860. When the threshold is met, the method 800 proceeds to block 850, where a determination is made if the insight template has less than a second threshold amount of positive reviews. If the number of positive feedback reviews is less than the second threshold, the insight template may be added to a blacklist at block 870 and removed from the template database until further action by an administrator. At block 880, when the insight template has more than the minimum second threshold of positive feedback, another determination is made, to see if the insight template has greater than a third threshold of positive feedback. When the template has more than the third threshold of positive feedback (e.g., 50%), a notification may be automatically generated and transmitted to an administrator to flag the insight template as particularly useful. Such feedback information collected from the user, may be used by the system to decide whether to display or hide such insights from the user in the future.

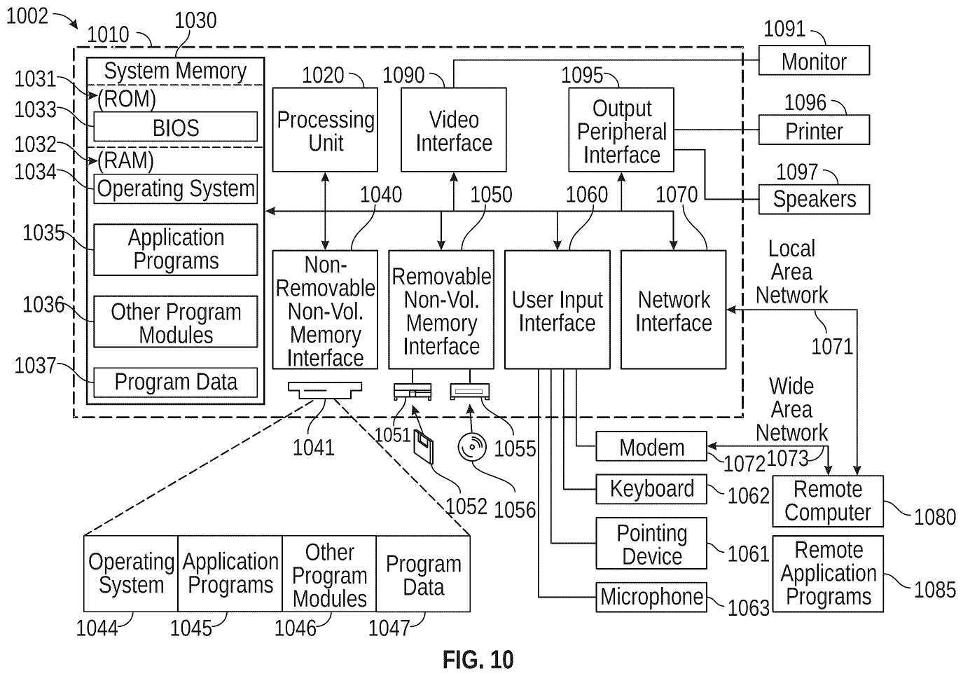

FIG. 10 is a diagram of an example computing system that may be used with some embodiments of the present invention. The computing system 1002 is only one example of a suitable computing system, such as a mobile computing system, and is not intended to suggest any limitation as to the scope of use or functionality of the design. Neither should the computing system 1002 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1002 may be implemented as a mobile computing system such as one that is configured to run with an operating system (e.g., iOS) developed by Apple Inc. of Cupertino, California or an operating system (e.g., Android) that is developed by Google Inc. of Mountain View, California.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 10, the computing system 1002 may include, but are not limited to, a processing unit 1020 having one or more processing cores, a system memory 1030, and a system bus 1021 that couples various system components including the system memory 1030 to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1002 typically includes a variety of computer readable media. Computer readable media can be any available media that can be accessed by computing system 1002 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1002. Communication media typically embodies computer readable instructions, data structures, or program modules.

The system memory 1030 may include computer storage media in the form of volatile and/or nonvolatile memory such as read only memory (ROM) 1031 and random access memory (RAM) 1032. A basic input/output system (BIOS) 1033, containing the basic routines that help to transfer information between elements within computing system 1002, such as during start-up, is typically stored in ROM 1031. RAM 1032 typically contains data and/or program modules that are immediately accessible to and/or presently being operated on by processing unit 1020. By way of example, and not limitation, FIG. 10 also illustrates operating system 1034, application programs 1035, other program modules 1036, and program data 1037.

The computing system 1002 may also include other removable/non-removable volatile/nonvolatile computer storage media. By way of example only, FIG. 10 also illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computing system 1002. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. The operating system 1044, the application programs 1045, the other program modules 1046, and the program data 1047 are given different numeric identification here to illustrate that, at a minimum, they are different copies.

A user may enter commands and information into the computing system 1002 through input devices such as a keyboard 1062, a microphone 1063, and a pointing device 1061, such as a mouse, trackball or touch pad or touch screen. Other input devices (not shown) may include a joystick, game pad, scanner, or the like. These and other input devices are often connected to the processing unit 1020 through a user input interface 1060 that is coupled with the system bus 1021, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1090.

The computing system 1002 may operate in a networked environment using logical connections to one or more remote computers, such as a remote computer 1080. The remote computer 1080 may be a personal computer, a hand-held device, a server, a router, a network PC, a peer device or other common network node, and typically includes many or all of the elements described above relative to the computing system 1002. The logical connections depicted in FIG. 5 include a local area network (LAN) 1071 and a wide area network (WAN) 1073, but may also include other networks. Such networking environments are commonplace in offices, enterprise-wide computer networks, intranets and the Internet.

When used in a LAN networking environment, the computing system 1002 may be connected to the LAN 1071 through a network interface or adapter 1070. When used in a WAN networking environment, the computing system 1002 typically includes a modem 1072 or other means for establishing communications over the WAN 1073, such as the Internet. The modem 1072, which may be internal or external, may be connected to the system bus 1021 via the user-input interface 1060, or other appropriate mechanism. In a networked environment, program modules depicted relative to the computing system 1002, or portions thereof, may be stored in a remote memory storage device. By way of example, and not limitation, FIG. 5 illustrates remote application programs 1085 as residing on remote computer 1080. It will be appreciated that the network connections shown are exemplary and other means of establishing a communications link between the computers may be used.

It should be noted that some embodiments of the present invention may be carried out on a computing system such as that described with respect to FIG. 5. However, some embodiments of the present invention may be carried out on a server, a computer devoted to message handling, handheld devices, or on a distributed system in which different portions of the present design may be carried out on different parts of the distributed computing system.

Another device that may be coupled with the system bus 1021 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 1072 may employ a Wireless Application Protocol (WAP) to establish a wireless communication channel. The communication module 1072 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

While having insights into how to respond to various data events in a business data set may be useful, in many cases the insights may be isolated from each other, requiring users to make substantial effort to identify possible causes of the highlighted events and thereby make the decision how to handle them. To address this shortcoming of conventional analysis systems, a system and method which allows to automate the identification of cause-effect relations between important business events discovered in the data sets aggregated from multiple data sources of various structure is discussed herein. By applying a combination of rules written by domain experts and data-generated rules derived by statistical correlation algorithms, the two components reinforcing each other and providing continuous improvement and automated self-learning of the system, an improved computer-based cause-effect identification system may be provided, thus providing more accurate results than conventional computer-based analysis systems.

The two analytical modules of the system used to identify cause-effect relationships are the rule engine and the statistical correlation engine. The rule engine uses expert rules stored as expert rule templates. The rules may be created by data experts, or may be automatically generated from data-generated rule templates created by the statistical correlation engine and verified by data experts. To improve the rule engine, the statistical correlation engine may verify existing expert rule templates against historical and incoming data to assess their reliability. The statistical correlation engine uses a correlation algorithm to analyze the historical data for the data set, and identify potentially correlated pairs of parameters. These correlated pairs may be used as basis for new expert rule templates and added to the expert rule template database. The solutions described herein also allow users to traverse chains of causality to find root causes of patterns within the data visually using various interfaces, providing a user-friendly way to derive insights from historical and incoming data for the data set.

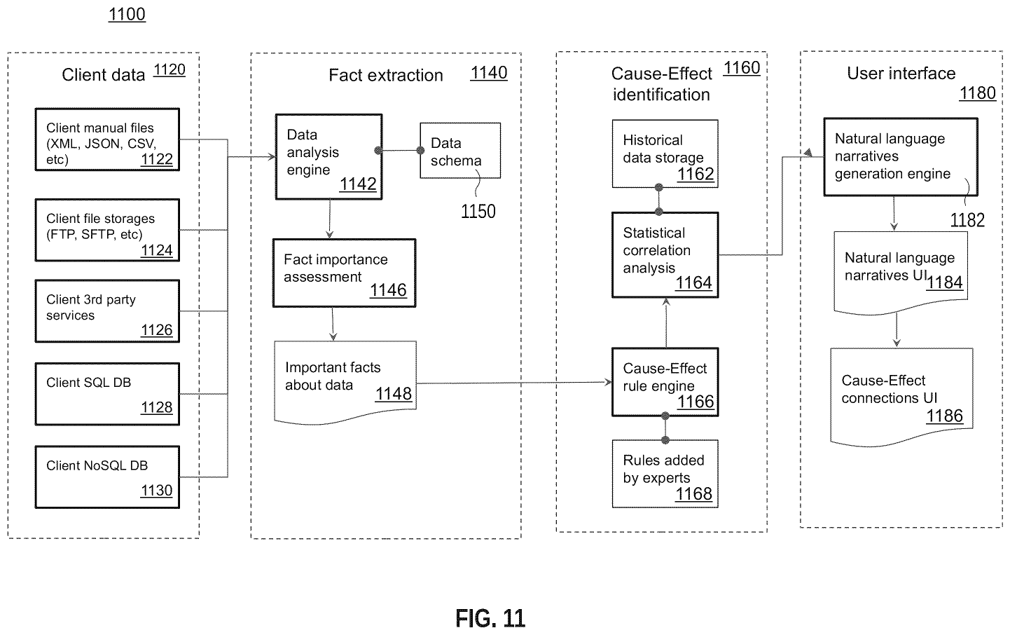

More specifically, and with reference to FIG. 11, shown is a block diagram illustrating an example of an operating environment 1100 for automatically identifying cause-effect relationships using hybrid systems, according to one or more embodiments of the disclosure. As shown, the operating environment 1100 may include a client data system 1120 that includes client data, a fact extraction module 1140 communicatively coupled to the client system 1120 via a network connection, a cause-effect identification module 1160, and a user interface module 1180. Client data system 1120 may include client manual files 1122, client file storages 1124, third party data storage services 1126, SQL databases 1128, and/or non-SQL databases 1130. Together, this variety of data sources may be combined to form a historical data set for the client and a stream of input data that is passed to the fact extraction module 1140 as it is generated.

The fact extraction module 1140 may include data analysis engine 1142, which receives the client data from client data system 1120 and aggregates it to form the data set, and data schema 1150, which as will be discussed below may be received from the client data system 1120 or may be automatically generated by the fact extraction module 1140. The data analysis engine 1142 may receive the data from the client data sources 1120 in the form of one or more structured data sets, each data set having its own corresponding configuration in the data schema module 1150. Using the data schemas from the schema module 1150 and the received data sets, the data analysis engine 1142 may generate a series of data structures known as “observed facts.” The generated observed facts from the input data sets may be transmitted to the fact importance assessment engine 1146. The fact importance assessment engine 1146 may apply thresholds to the observed facts to identify which observed facts are statistically significant. Observed facts that satisfy the thresholds, which may be predetermined values received as inputs from data experts, for example, are identified as “important” observed facts 1148, and are passed on to the cause-effect identification module 1160.

The fact extraction module 1140 may be communicatively coupled to the cause-effect identification module 1160 and user interface module 1180. Cause-effect identification module 1160 includes historical data storage 1162, which stores the data set data from past predetermined time periods. As explained further below, the data from the historical data storage 1162 may be updated with input data from the data stream and used by the statistical correlation analysis module 1164 to update correlation values in some or all existing rule templates. When updated correlation values hit predetermined threshold values indicating that the rule templates are being contradicted, the statistical correlation analysis module 1164 may transmit an alert to a system administrator, or even remove rule templates received via the cause-effect rule engine 1166 (which is in communication with the fact extraction module 1140) from the rule template database 1168 in some embodiments. In the context of the current invention, a rule refers to a predefined statement or condition that outlines a potential cause-effect relationship between specific factors or events and the observed changes in business metrics. Rules may be developed based on expert knowledge and domain expertise in the relevant field. These rules can take the form of logical statements or conditional expressions that describe how certain inputs or events can lead to specific outcomes or changes in the metrics of interest.

Rules serve as guidelines or heuristics to identify potential causes of business events. By applying these rules to the available data, the system can highlight potential causes that might explain the observed changes in the metrics. Rules are not a guaranteed proof of causality, but rather indications of potential relationships between factors and metric changes which need further algorithmic validation against the data set. The rule includes two main parts: (a) condition pattern and (b) potential cause pattern, both parts being similar in structure, i.e. templates to be matched against business events discovered in the input data set. Structural components of the expert rule template data structure within the rule template database may include:
Cause parameter and effect parameter;
Cause change direction and effect change direction;
Cause change percentage threshold and effect change percentage threshold;
Dimension constraints;
Time Interval;
External Factors;
Time Lag; and
Correlation Strength.

Within the expert rule templates, “parameters” are defined as specific metrics or measurements within the business data set that is being analyzed. Examples of parameters may include sales revenue, customer satisfaction scores, website traffic, or product unit sales. Parameters help identify the specific aspect of the business that is being examined for potential cause-effect relationships. The cause parameter may be the parameter of the data set that is suspected of causing a change in a different parameter in the data set (i.e., the effect parameter within the pair of parameters).

The “Change Direction” field specifies the direction in which each parameter is expected to change in relation to the cause-effect relationship being analyzed. A parameter's change direction can be defined as either an increase or a decrease. This item provides a directional context for interpreting the impact of potential causes on the parameter in question. The change direction is utilized to identify potential correlations from the input data in the data stream. For example, if the parameter is sales revenue and the change direction is set to “increase,” the system will focus on identifying potential cause parameters that also experienced a change event in either direction that may lead to an increase in sales revenue. In some embodiments, the statistical correlation analysis module 1164 may identify potential cause parameters from existing rule templates, which codify identified links between the effect parameter and other parameters of the data set. The “Change Percentage Threshold” field represents the minimum threshold or magnitude of change required for the parameter change to be considered significant or meaningful. Having a percentage threshold filters out minor fluctuations or noise in the data and focuses on changes that have a substantial impact. This threshold can be expressed as a percentage, indicating the minimum percentage change required to trigger further analysis. The specific value for the change percentage threshold may vary depending on the specific business domain and the sensitivity of the parameter being analyzed.

In addition to the foregoing, in some embodiments the expert rule templates may also include “Dimension Constraints” fields, referring to additional criteria or conditions that need to be satisfied by the business events in order to be considered relevant for the cause-effect analysis. Dimensions provide additional contextual information about the events and help narrow down the scope of the analysis. Dimensions can represent various aspects of the business, such as geographical location, customer segment, product category, or time period. By specifying dimension constraints, the expert rule templates can focus on specific subsets of the data or isolate particular segments for analysis, permitting for more targeted and relevant insights. Optionally the dimension constraints may be extended to allow for the inclusion of multiple dimensions simultaneously. This permits analysis of cause-effect relationships within specific combinations of dimensions. For example, analyzing sales revenue changes based on the interaction of dimensional constraints for geographical location, customer segment, and product category allow users to identify more granular causes for various changes.

Similarly, including an optional time interval field as part of the template allows for the analysis of cause-effect relationships within specific time periods. This can help identify temporal patterns and trends in the data. The time interval field value could be defined as a fixed duration (e.g., weekly, monthly, quarterly, or yearly) or as a dynamic duration based on the frequency of data updates or business cycles. Another temporal limitation may be implemented as a time lag field which accounts for delays or time gaps between the cause and effect. In many scenarios, cause-effect relationships may not manifest immediately but exhibit a time delay. By considering time lags, the system can identify and measure the temporal relationship between events, providing insights into the time-dependent nature of cause-effect relationships.

Also, the template may incorporate fields that account for external factors or variables that may influence the cause-effect relationships. These factors could include market conditions, economic indicators, internal activities in the company that are not reflected in the data sets utilized for the present analysis, competitor activities, or environmental factors. Such factors or accompanying events can be either retrieved and integrated into the system via automated APIs or entered manually by the users. Furthermore, a correlation strength field may capture the desired strength of correlation between the cause and effect. This allows for the specification of a correlation threshold or range, indicating the minimum level of correlation required to consider a cause-effect relationship as significant, in other words the rule is only invoked if the correlation between the cause and the effect is consistent enough across the data set. By incorporating correlation strength, the system can focus on identifying stronger relationships and filter out weaker or less meaningful associations.

The statistical correlation analysis module 1164 functions based on the principle that two events that occur consistently close to each other in time and/or in space, can be related to each other as cause and effect. In order to calculate the correlation coefficients, the system utilizes historical data, for example, at least two standard business cycles (typically weeks, but also quarters, months, and years, in various embodiments). The statistical correlation analysis module 1164 may include the following sub-components:
Event template generator;
Event list iterator;
Historical data analyzer; and
Candidate patterns generator.

The Event Template Generator is responsible for creating data-generated event rule templates that define the structure and criteria for potential cause-effect relationships within the statistical correlation module. It takes into account the specific business domain and the variables of interest. The generator constructs event templates by incorporating components such as the business measure, change direction, change percentage threshold, dimension constraints, time interval, external factors, and time lag. These templates serve as the basis for identifying and analyzing correlations between events.

The data-generated event rule templates include similar corresponding components used for expert rule templates in the rule engine 1166, with a difference being the absence of the correlation strength component (as the function of the statistical correlation analysis module 1164 is calculate the correlation strength). The constituent fields of the rule template generated by the statistical correlation analysis module include.
Cause parameter and effect parameter;
Cause change direction and effect change direction;
Change percentage threshold;
Dimension constraints[
Time Interval;
External Factors; and
Time Lag.
   Each of the above listed fields are substantially similar to the corresponding fields for the expert rule templates. The correlation strength component may be added when an expert reviews a data-generated event rule template and adds the reviewed event rule template to the expert rule database, at which point historical data may be used to determine the correlation strength for the event rule template in the data set.

Regarding the other components of statistical correlation analysis module 1164, the event template pair iterator component may sequentially process each pair of event templates, comparing and analyzing them together. This approach allows for a comprehensive examination of potential causal relationships between different variables and dimensions defined in the event templates in order to match them against the rules contributed by the expert and capture potential cause-effect relationships. The historical data analyzer component is responsible for analyzing historical data to assess the relationships between events based on the event templates. It examines the data within the specified time intervals and spatial constraints formally calculating the consistency coefficient, i.e. the percent at which the two business events in the given pair take place simultaneously, individually or with a certain time lag. Lastly, the candidate patterns generator generates potential cause-effect patterns based on the correlations identified by the historical data analyzer. It combines the correlated events and their attributes, taking into account the event templates and the calculated correlation coefficients. The generator aims to extract meaningful patterns from the data, highlighting potential cause-effect relationships that exhibit consistent correlations. By incorporating these key components, the statistical correlation analysis module 1164 can systematically analyze historical data, identify correlations between events based on event templates, calculate correlation coefficients, and generate candidate patterns for potential cause-effect relationships that can be later validated by the experts and turned into high reliability rules.

In addition to formulating new expert rule templates, statistical correlation analysis module 1164 may, in the course of the system operation, receive subsequent data via the stream of input data. The subsequent data may be analyzed against by both expert-originated rules and rules derived from statistical correlations. When the subsequent data includes correlations that are not consistent with the rules added by the experts, the system may alert the a system administrator about such inconsistencies via email or other notification channel, thereby securing timely rule update and continuous processing quality improvement.

Historical data storage 1162 may be implemented as a storage sub-system for historical data which permits continuous incremental update of the expert rule templates with the newly generated insights and efficient retrieval of such insights. The historical data storage 1162 allows to the system 1100 to go beyond the one-time generation of rule candidates for expert approval and correction, but rather continuously add new facts and correlations thereby creating a self-learning cycle. As with any statistical methods, there is a positive correlation between amount of the stored data (or in other words the length of the observation period) and the precision of statistical coefficients. Therefore, the optimal functioning of the historical data storage supposes immediate storage of all the newly received data objects from the stream of input data and re-calculation of the statistics of the expert rule templates.

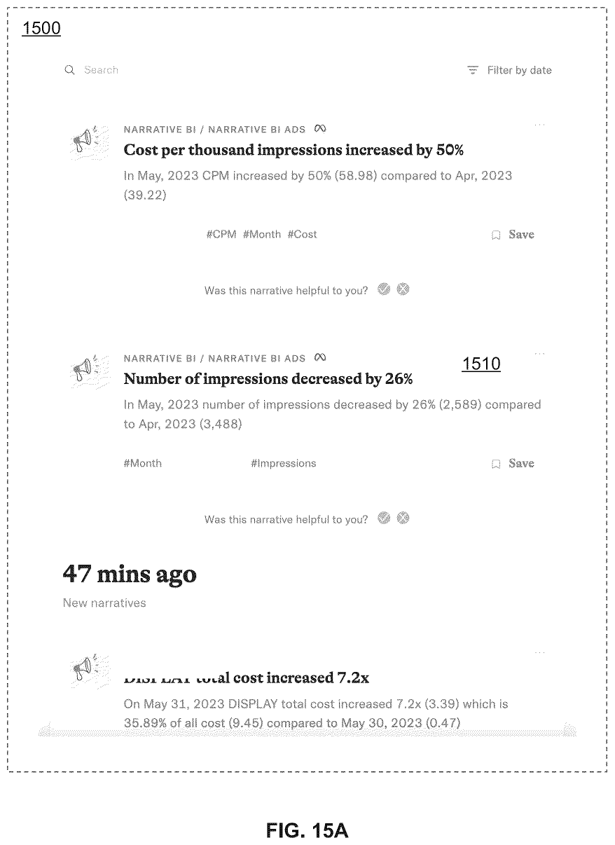

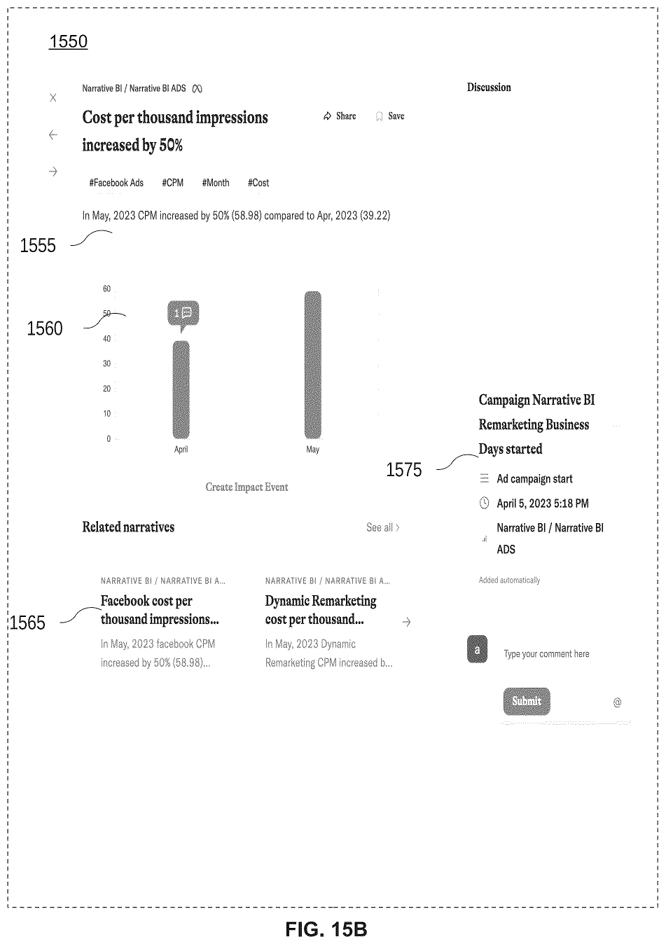

The natural language narratives generation engine 1182 of the user interface module 1180 may receive the underlying event data, and information regarding any satisfied expert rule templates from the cause-effect identification system 1160, and use them to generate insight graphic interfaces displaying the cause-effect relationships signified by the expert rule templates. Natural language narrative interfaces 1184 and visualizations associated with the satisfied expert rule templates may be transmitted directly by the user interface system 1180 for display. In some embodiments, the insight graphic interface for a satisfied expert rule template may include user-selectable links to different insight graphic interfaces using cause-effect connections interfaces 1186. The different insight graphic interfaces may each be associated with different expert rule templates that include a common cause parameter or effect parameter with the satisfied selected expert rule template of the original insight graphic interface, as is shown in FIGS. 15A-C.

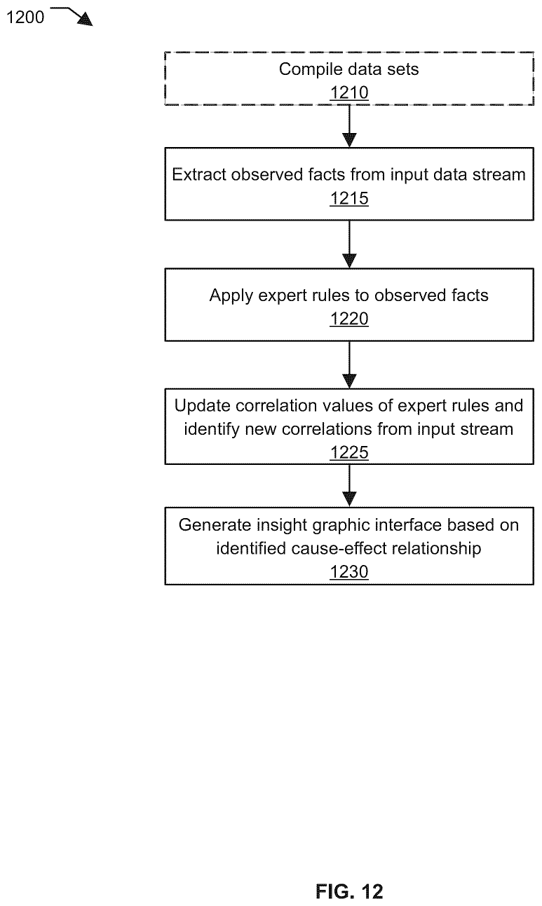

FIG. 12 is a flow diagram illustrating an example method 1200 of using a hybrid system to identify cause-effect relationships in a data set using historical and a stream of subsequent input data, according to one or more embodiments of the disclosure. Process 1200 may use processing logic, which may include software, hardware, or a combination thereof. For example, process 1200 may be performed by a system including one or more components described in operating environment 1100. At the start of method 1200, the data sets underlying the cause-effect analysis may be compiled from a variety of sources at step 1210. This may require substantial pre-processing, in the form of extracting data from the original source and normalizing the data to a single structured format. First, the underlying data sources may be identified. These could be databases, websites, APIs, or even hard copy documents. The data presentation formats, access credentials, specific data features and table/field/graph/etc. schemas may be configured in the system in a formal presentation format. The data may then be extracted from the identified sources. If an API is available, it can be used to extract data programmatically. For websites without APIs, web scraping tools might be used. In the case of hard copies, data might be input manually or scanned using OCR (Optical Character Recognition) technology.

Extracted data usually contains errors, duplicates, or irrelevant information. Accordingly, the extracted data may be cleaned to remove these inaccuracies. This could involve removing or correcting erroneous data, handling missing values, de-duplication, and performing sanity checks. The cleaned data may then be normalized and transformed into a standard format for use by the system shown in FIG. 11. Given that data could be coming from various sources with different formats, the normalization may entail standardizing text case, converting data types, date and currency formats, scaling numerical values, categorizing data, aggregating the data to the required time period, e.g. calculating weekly total and average values in case the normalized format requires weekly data snapshots and the raw data has daily granularity.

Once all cleaned data is normalized, the normalized data may then be combined into a single structured format and stored in the common storage so that the data processing algorithms can access the data regardless of the initial source. Each of the above-described processes could be fully automated or semi-automated using software tools, custom scripts, or data processing platforms depending on the complexity and scale of the data involved.

In step 1215, a server (e.g. fact extraction system 1140) may extract observed facts from the data set and/or input data stream, which may be stored as event data objects. In order to correctly extract observed facts from the data source, the application backend system 1140 uses certain information about the data set configuration or schema 1150 and its constituent parts. The event data objects may be data structures stored by the application backend 1140 that track a state of a certain parameter during a predetermined period of time as a numerical trend, or comparison of the values of the parameter in two different periods of time. The data schema of the data set may accordingly be metadata labeling data columns of the data set, the types of data being one of a date column, a numeric column, and a context column. Date columns may indicate the beginning and end of the period for which the data in other columns was collected. Numeric columns may include values indicating various business metrics, and context columns may indicate various dimensions for which the data in the numeric columns was collected. An exemplary data set may include the following columns:
Date columns: start_date, end_date;
Numeric columns: budget_spent, impressions, clicks, conversions;
Context columns: gender, age, country, device.

The data schema may be obtained in several different ways. In some embodiments, the data schema is simply received by the fact extraction system 1140 from the client data system 1120. The data schema may be elaborated by a data expert upon receipt of the data set in other embodiments. Furthermore, in some embodiments the process of the dataset configuration can be automated or semi-automated using the types of data columns (date, numeric or string) and/or a previously created data set configurations since the column names can be repeated in the newly integrated data sources.

Once the data schema 1150 is obtained, the data analysis engine 1142 may generate observed facts from numeric-type data columns of the data set based on the data schema 1150 at step 1215. Each observed fact may be a data structure that includes an amount of change of a corresponding numeric-type data column over a predetermined period of time. Once the meaning of the data set columns is known, the changes and fluctuations in the data metrics may be observed overtime, and stored as observed facts. In some embodiments, an observed fact is a structured object which may include the following fields:
(1) start time (based on corresponding date column data);
(2) end time;
(3) metric (i.e. the numeric data label for the observed fact);
(4) metric value for the start time;
(5) metric value for the end time;
(6) direction of change (increase or decrease);
(7) percent of change;
(8) dimension (when appropriate); and
(9) dimension value.

The length of the period for the observed facts can vary from one millisecond to one year (or even longer), depending on the nature of the observed data. If the length of period in the fact object is different from the data granularity of the data set, an aggregation function may need to be applied to the data (usually average or sum). Examples of observed facts are:
Generic fact (empty dimension)
Metric: number of users
Start period: Feb. 19, 2023
End period: Feb. 20, 2023
Start period value: 69
End period value: 107
Type of change: increase
Percent of change: 55%
Fact with a dimension (country)
Metric: number of page views
Dimension: country
Dimension value: Germany
Start period: Feb. 19, 2023
End period: Feb. 20, 2023
Start period value: 14000
End period value: 7000
Type of change: decrease
Percent of change: 50%

In some embodiments, the expert rule templates may be applied to all observed events, which may be desirable when a user wishes to track all potential cause-effect relationships. However, in other embodiments the user may only wish to view statistically significant cause-effect relationships. In such embodiments, the observed facts may be filtered using an importance assessment filter (which sets thresholds to limit the number of priority observed facts analyzed by the rule templates). From the generated observed facts, a subset of priority observed facts may be identified by the fact importance assessment engine 1146 based on a plurality of priority factors associated with each observed fact at step 1220. Each priority factor may be a value assigned to the observed fact, and may be derived from data within the observed fact, or may be separately assigned, for example, based upon the column of the data set associated with the observed fact. This is based on the principle that not all the facts about the changes in metrics are significant enough to be taken into account in the decision making process. The following priority factors can be taken into account when measuring priority of an observed fact:
(1) Percent of change: where larger changes are assigned a higher priority than observed facts having smaller changes (the percent of change, as shown above, is a field in the observed facts in some embodiments);
(2) Value range coefficient: with larger absolute numbers, the importance of facts becomes more sensitive to the percent of change (e.g. on a website with 1M visitors, a 10% daily increase [which would mean+100K users] will be considered an important event, while jump from 100 to 200 users is a lot more likely and therefore less important [even though formally it's a significant 100% increase]; this may be accounted for by, for example, setting a value range coefficient to 0.2 for the value range of 0-1000, 0.3 for the range of 1000-10,000, etc.);
(3) Metric importance coefficient: some metrics are more sensitive to change than others, and may be pre-assigned an importance coefficient increasing the likelihood of being selected as a priority observed fact;
(4) Dimension importance coefficient: certain dimension labels, like country or age, can be weighted as having a higher priority than other dimension labels associated with the observed facts;
(5) Dimension value importance coefficient: certain dimension values can be configured to be more important, (e.g., the United States and Germany can be configured to be most important countries when associated with observed facts).
   In some embodiments, all coefficient values used to determine fact priority may be numbers in the range from 0 to 1.

Also, in some embodiments, the overall observed fact priority may be captured by a fact significance score associated with each observed fact. This may be calculated, for example, by multiplying the change value with all the coefficients:

Overall fact significance=Overall Change value*Value range coefficient*Metric importance coefficient*Dimension importance coefficient*Dimension value importance coefficient

In other embodiments, fewer or more coefficients may be used to determine the fact significance scores for each observed facts. The priority observed facts may be selected based on the fact significance scores, where a predetermined N number of facts are selected, or may be selected based on having greater than a predetermined threshold priority value, in various embodiments. The N number can be configured empirically depending on the size of data source and/or user preferences. The most important group can be displayed in the feed with the highest priority, other groups can be displayed upon clicking a “view more” button, or scrolling down the page.

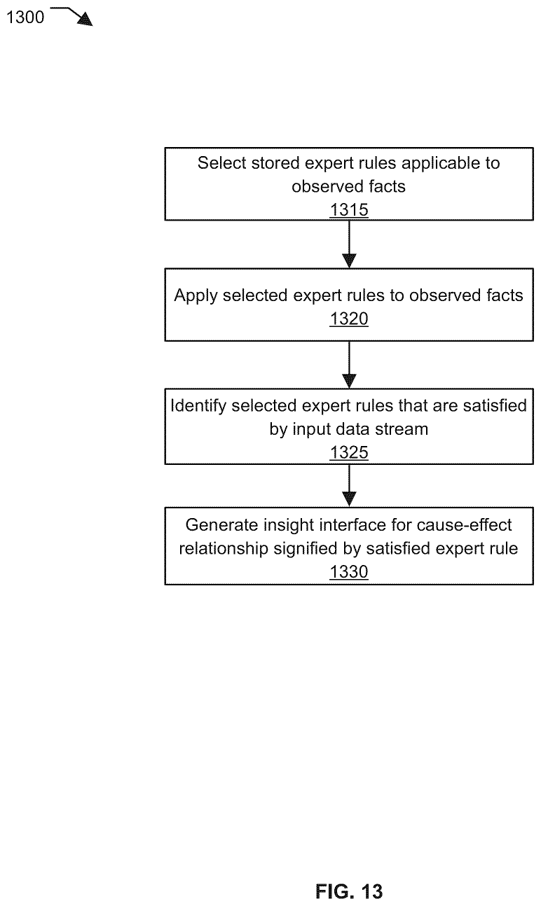

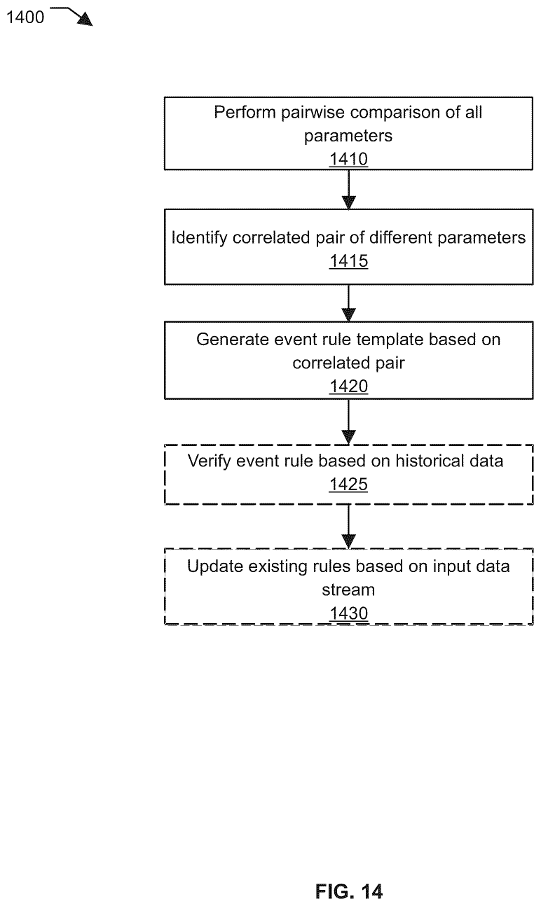

To automatically identify the cause-effect relationships, generally the expert rule templates are then applied to event data objects extracted from the stream of input data at step 1220. The stream of input data may take the form of periodic transmissions of updated versions of the data set in some embodiments, or may take place in a more piecewise form. In embodiments where the data stream comes from a variety of client data sources, the same steps used to assemble the initial data set described above may be repeated. When the thresholds of an expert rule template are satisfied, signifying existence of a cause-effect relationship, the underlying data may be presented in an interface for the user to clearly identify the relationship, as well as related relationships in some embodiments at step 1230. A rule template is determined to be satisfied when the both the cause parameter change threshold and the effect parameter change threshold are met or exceeded by the extracted event data objects within a single time interval. The process of identifying cause-effect relationships using the rule-based engine is described in FIG. 13. In parallel with the operation of the rule-based engine, the statistical correlation engine may function to both modify existing expert rule templates based on the stream of input data and identify new rule candidates based on one or both the stream of input data and the historical data at step 1225. The function of the statistical correlation engine is shown in greater detail in FIG. 14. Finally, based on insights from the rule-based engine and the statistical correlation engine, the insight graphic interface is generated and provided for display on a display device, highlighting both the cause-effect relationship and other related metrics at step 1230.

As noted above, an expert rule-based engine is used in the hybrid system to identify cause-effect relationships between parameters of a data set. FIG. 13 is a flow diagram illustrating a data flow 1300 for using an expert rule template-based approach to identifying cause-effect relationships of a data set according to one or more embodiments of the disclosure. Data flow 1300 shows how, based on the received column-based structured dataset 1305 and data schema 1150, the data analysis engine 1142 identifies satisfied expert rule templates from observed facts extracted from a stream of input data.

At step 1315, expert rule templates may be selected from the expert rule template database based on the event data objects extracted from the stream of input data. Extraction of the event data objects, described above as “observed facts,” from the stream of input data is described above as taking place in method 1200. The selected expert rule templates may be selected from the database based on having input parameters that match the parameters of one or more of the event data objects. Each expert rule template stored within the expert rule database may include a cause parameter from the data set, an effect parameter from the data set, change thresholds for both the cause and the effect parameters and time intervals for both the cause and effect parameters. Four sample cause-effect extraction rules are described below, in both textual form and structured format (which is used to store the rule in the database). Various types of database systems can be used for the expert rule template database, including but not limited to relational databases, document databases, or graph databases.

| Rule components | Cause | Effect |
|---|---|---|
| Parameter | Advertising budget | Ad impressions |
| Change Direction | Increase | Increase |
| Change Percentage Threshold | 5% | 4% |
| Dimension Constraints | All dimensions | All dimensions |
| Time Interval | 1 day | 1 day |
| External Factors | None | None |
| Time Lag | 2 days | |
| Correlation Strength | Strong | |

### Rule 1: Advertising Budget to Ad Impressions

The first rule suggests that an increase in the advertising budget (i.e. the cause parameter) by 5% minimum leads to an increase in ad impressions (i.e., the effect parameter) by at least 4% within a span of 1 day, with no external factors influencing this relationship. The 2-day time lag indicates that the effect on ad impressions can be delayed to up to two days after the increase in the advertising budget. A strong correlation indicates a consistent and significant relationship between these two factors. From a business perspective, it implies that higher investment in advertising generally leads to more visibility for the ads.

| Rule components | Cause | Effect |
|---|---|---|
| Parameter | Ad impressions | Ad clicks |
| Change Direction | Increase | Increase |
| Change Percentage | 4% | 1% |
| Threshold | | |
| Dimension Constraints | Platform: Facebook ® | Platform: Facebook ® |
| Time Interval | 1 day | 1 day |
| External Factors | None | |
| Time Lag | 1 day | |
| Correlation Strength | Weak | |

### Rule 2: Ad Impressions to Ad Clicks

The second rule indicates that an increase of minimum 4% in ad impressions on Facebook®, owned by Meta Platforms, Inc., of Menlo Park, California, leads to at least a 1% increase in ad clicks on the same platform within a 1-day time interval. The 1-day time lag suggests the increase in ad clicks is observed either on the same day or the day following the increase in ad impressions. However, the correlation is weak, indicating that while there is a relationship, other factors may also significantly influence ad clicks (like ad quality, targeting, which can't be formally calculated). From a business standpoint, this suggests that increasing ad impressions may lead to more clicks.

| Rule components | Cause | Effect |
|---|---|---|
| Parameter | Ad clicks | Website visits |
| Change Direction | Increase | Increase |
| Change Percentage Threshold | 1% | 0.8% |
| Dimension Constraints | Platform: Facebook ® | Platform: Website |
| Time Interval | 1 day | 1 day |

| | |
|---|---|
| External Factors | Web server uptime (positive correlation) |
| Time Lag | None |
| Correlation Strength | Strong |

### Rule 3: Ad Clicks to Website Visits

The third rule suggests that an increase in ad clicks of min 1% on Facebook® corresponds to an at least 0.8% increase in website visits within a day, given that the web server uptime positively influences this outcome. No time lag suggests the effect is immediate. A strong correlation implies a consistent and significant link between these variables. In business terms, this means that more clicks on the ads lead to more traffic on the website, assuming that the server is consistently up and running.

| Rule components | Cause | Effect |
|---|---|---|
| Parameter | Website visits | Sales conversions |
| Change Direction | Increase | Increase |
| Change Percentage Threshold | 0.8% | 0.2% |
| Dimension Constraints | Platform: Website | Platform: Website |
| Time Interval | 1 day | 1 day |

| | |
|---|---|
| External Factors | Web server uptime (positive correlation) |
| | Number of errors in the error log (negative correlation) |
| Time Lag | 2 days |
| Correlation Strength | Weak |

### Rule 4: Website Visits to Sales Conversions

The fourth rule denotes that an increase of min 0.8% in website visits leads to at least a 0.2% increase in sales conversions on the website within a one-day interval. This happens given that the web server uptime positively influences this outcome and the number of errors in the error log negatively influences it since software bugs might disrupt the operation of the shopping cart and payment modules. Time lag of two days suggests that the conversion may not be immediate. A weak correlation signifies the conversion rate is hardly predictable and might appear to be inconsistent. In business terms, this means that an increase in web traffic, assuming the website is functioning properly and with minimal errors, leads to more sales conversions.

At step 1320, the selected expert rule templates may be applied to the list of observed facts extracted from the data stream. For example, when an event data object includes both the cause parameter and the effect parameter, and the change thresholds are both exceeded within the event data object, the underlying expert rule is determined to be satisfied. Table 2 shows actual observed statistical correlations between the changes in pairs of parameters described the four exemplary rules. The correlation coefficients may be used as additional criteria of cause-effect relation identification along with the structural rules. In order to calculate the below statistics, the historical data storage is used, which allows the system to observe the metric changes for the past days (generally the more days are covered, the higher the stats precision).

TABLE 2
Observed correlations for expert rule templates

| | Average | | Average | |
|---|---|---|---|---|
| | Change | | Change | |
| Business | amount | Business | amount | Correlation |
| Measure 1 | 1 | Measure 2 | 2 | probability |
| Advertising | 20% increase | Ad impressions | 15% increase | 80% |
| budget | | | | |
| Ad impressions | 15% increase | Ad clicks | 8% increase | 60% |
| Ad clicks | 8% increase | Website visits | 8% increase | 90% |
| Website visits | 8% increase | Sales | 3% increase | 50% |
| | | conversions | | |

Table 53 shows the stream of input data (the list of observed facts for the recent days). As seen in the FIG. 11, the data is aggregated from various heterogeneous data sources, pre-processed, normalized and filtered to match the business importance criteria.

TABLE 3
Stream of input data

| Event data | Business Measure | Change Direction | Change amount |
|---|---|---|---|
| Apr. 20, 2023 | Advertising budget | Increase | 10% |
| Apr. 21, 2023 | Ad impressions | Increase | 6% |
| Apr. 21, 2023 | Ad Clicks | Increase | 5% |
| Apr. 21, 2023 | Website visits | Increase | 5% |
| Apr. 22, 2023 | Conversions | Increase | 0.1% |
| Apr. 22, 2023 | Server Uptime | Unchanged | N/A |
| Apr. 22, 2023 | Number of errors in | Increase | 200% |
| | the log | | |

The expert rule templates may be retrieved from the database and applied to each data object in the stream of input data one by one, and satisfied expert rule templates are identified at step 1325. In the above-described example, rule 1 (Advertising Budget to Ad Impressions) suggests a possible cause-effect relation between advertising budget and ad impressions metrics. When the cause and effect parameters for an expert rule template are located in the stream of input data, the two corresponding objects and their numeric parameters are compared to those set by the rules. In the example data shown, the actual data satisfies the requirements of rule 1 (the effect date lags less than 2 days behind the cause, the increase of both metrics during the time period shown satisfies the threshold, as the advertising budget increased by 10% and the ad impressions increased by 6% one day later).

Furthermore, for the example above, rule 2 (Ad Impressions to Ad Clicks) can be matched against the corresponding pair of observed facts in the stream of input data. The cause parameter add impressions has increased by 6% in the observed time period, and the ad clicks have increased by 5%. The actual data in the stream of input data exceeds the temporal and numeric values required by the corresponding fields of the second rule, and therefore a cause-effect relation can be identified with a required degree of confidence. As the result, two cause-effect relations in the example shown above allows the system to build a cause-effect chain (budget->impressions->clicks) which gives an additional value to the user exploring the data as it gives a broader picture of the actual business processes.

By contrast, when the fourth example rule (Website Visits to Sales Conversions) is applied to the corresponding observed facts, the numeric parameters of the actual data don't pass the rule's thresholds. Therefore, the cause-effect relationship between the cause parameter (website visits) and the effect parameter (sales conversions) is not identified with the required level of confidence. The external factor (200% increase in number of errors in the log) also suggests why the expected effect wasn't reached for the cause. In a particular embodiment of the invention, an alert can be sent both to the users of the system and to the expert who authored the rule, that there was a discrepancy between the rule matching (true) and the statistical correlation (false). The users of the system may take advantage of the timely alert by paying attention to the external factor (software errors disrupting the sales process). The expert who authored the rule will see the evidence that the external factor specified in the rule can actually take effect, i.e. the rule is composed correctly and doesn't need any amendments. Once the data analysis is over, the data objects from the stream of input data are placed into the historical data storage, and the statistical correlations may be re-calculated to provide improved precision and more reliable rule verification in the future analysis iterations. Based on the satisfied expert rule template, narrative text and one or more visualizations associated may be transmitted to a display device and caused to be displayed. at step 1330.

Furthermore, the subsequent data from the stream of input data may be added to the data storage structure that includes the data set, and the metrics of the satisfied expert rule template may be recalculated in an optional step (not shown in method 1300) by the statistical correlation analysis module. The addition of the subsequent data to the data structure may be triggered, for example, in response to the receipt of the subsequent data, so that the data structure is being updated whenever new data is received from the client data systems. The recalculation may include repeating the pairwise comparison of all the parameters of the data set and determining the persistence probabilities of pairs of the different parameters. In some embodiments, the recalculation can trigger augmenting the behavior of the satisfied expert rule template. For example, an alert may be generated in response to one of the expert rule templates in the expert rule database or the new expert rule template being contradicted by the data of the updated historical data set. An expert rule template may be contradicted when only one change threshold of the cause parameter or the effect parameter is satisfied over the same time interval, while the other parameter's change threshold is not satisfied. The alert may then be generated in response to identification of the contradiction by the updated historical data set. While data-based contradictions to expert rule templates are one way the expert rule templates may be altered or removed from the database, there are other ways this may occur. For example, the insight interfaces illustrating identified cause-effect relationships may include areas to receive feedback from users on the displayed cause-effect relationship. The feedback may be used to determine if the one of the expert rule templates in the expert rule database or the new expert rule template is contradicted by the subsequent data.

FIG. 14 is a flow diagram illustrating an example method 1400 of using statistical correlation approach to generate and modify rule templates according to one or more embodiments of the disclosure. At step 1410, pairwise comparison may be performed for each combination of parameters of the data set. To perform this comparison, a historical data storage is incorporated into the system securing persistence of all observed facts (changes in parameters over a set period of time). An example of such a storage with data populated for 10 days is displayed below in Table 4.

TABLE 4
Example historical data set

| | | Number | Number | Website | |
|---|---|---|---|---|---|
| | Page Load | of | of | Downtime | Ad Spend |
| Date | Time (sec) | Page Views | Sales | (min) | ($) |
| Mar. 10, 2023 | 1.5 | 15000 | 200 | 0 | 500 |
| Mar. 11, 2023 | 2 | 14500 | 190 | 0 | 500 |
| Mar. 12, 2023 | 2.5 | 14500 | 180 | 15 | 500 |
| Mar. 13, 2023 | 1.5 | 15000 | 200 | 0 | 500 |
| Mar. 14, 2023 | 3 | 13500 | 170 | 20 | 500 |
| Mar. 15, 2023 | 2.5 | 14000 | 180 | 0 | 500 |
| Mar. 16, 2023 | 2 | 14500 | 185 | 0 | 500 |
| Mar. 17, 2023 | 1.5 | 15000 | 200 | 0 | 500 |
| Mar. 18, 2023 | 1.5 | 16500 | 200 | 0 | 500 |
| Mar. 19, 2023 | 2.5 | 15000 | 180 | 30 | 500 |
| Mar. 20, 2023 | 2 | 14500 | 190 | 15 | 500 |

In this sample data, various parameters are tracked day-to-day. For example, the parameters shown include parameter values for page load time, number of page views, number of sales, website downtime, and ad spend. By analyzing changes in these parameters, the system can learn to identify patterns and infer cause-effect relationships.

To do so, all possible pairs of parameter change and change direction may be generated over a plurality of predetermined correlation time periods. Then, a coincidence probability of each parameter pair+direction combination may be determined, where the coincidence probability may be defined as the number of predetermined time periods where the change direction of the parameters is consistent. For example, a coincidence probability for a pair of parameters may be expressed as an increase in a first parameter takes place along with the decrease in a second parameter on 80% of the observed days (where “days” is the predetermined time period for the parameter). From the set of all possible pairs of parameter change and change direction, one or more correlated pairs may be identified at step 1415 based on a coincidence probability (also known as a persistence probability) of the different parameters of the identified correlated pairs. For example, the pairs may be sorted by coincidence probability, where pairs having a coincidence probability greater than a user-set predetermined correlation threshold may be identified as correlated. In the above cited example, the first and second parameters and their respective directions may be identified as correlated when the correlation threshold is set at 75%.

Table 5 shows correlations identified in the historical data in Table 4. For instance, an increase in page load time often coincides in the historical data with a decrease in the number of page views and the number of sales. There is also a correlation in the historical data between website downtime and a decrease in the number of page views and the number of sales. Such correlations are identified programmatically and may be stored in the rule database as candidate rule templates, referred to above as the data-generated event rule templates. The data structures for the event rule templates may specify the linked candidate cause and effect metrics, the directions of their change, and the coincidence probability for the cause and effect events.

TABLE 5
Correlated pairs of parameters from the exemplary historical data set

| | Cause Change | | Effect Change | Coincidence |
|---|---|---|---|---|
| Cause Metric | Direction | Effect Metric | Direction | Probability |
| Page Load | Increase | Number of | Decrease | 0.8 |
| Time | | Page Views | | |
| Number of | Decrease | Number of | Decrease | 0.9 |
| Page | | Sales | | |
| Views | | | | |
| Website | Increase | Number of | Decrease | 0.8 |
| Downtime | | Page Views | | |

In some embodiments, the statistical correlation analysis module may automatically populate the fields of the event rule templates for identified rule candidates. The rule candidates may be provided for review in a rule candidate interface, which would be similar to example rules 1-4 shown above, for review by experts. The rule candidate interface may at least include the proposed cause and effect parameters, the change directions, and the threshold change amounts, and a selectable option to receive user input to add the rule candidate to the expert rule database. The data experts may use the rule candidate interface to filter out the false correlations and confirm that the rule candidate is consistent with principles of the business domain before being added to the expert rule database in some embodiments. For example, the dimension constraints field may be automatically populated when the correlation analysis module identifies that the coincidence probability is high for two parameters only in certain country or for certain age group (where the dimension constraint field value would be the country or age group in question). In many cases, the expert does not simply approve the candidate rule reflected in the event rule template, but instead may manually populate and clarify field values. Also, in some cases the expert might swap cause and effect fields because the algorithm might wrongfully identify which of the correlated parameter changes is the cause parameter and which is the effect parameter. That is, occasionally human intervention may be required to use knowledge from the relevant field to determine which parameter is the cause and which is the effect.

At step 1420 a correlated pair of different parameters may be used to create a new expert rule template in the expert rule template database. In optional step 1425, the new expert rule template may be verified using one of historical data or subsequent data received in the stream of input data. This may be done by, for example, recalculating the values of the cause and effect parameter changes, and adjusting the change thresholds to reflect the new values. This verification process may be extended to existing expert rule templates in optional step 1430, to ensure that all rule templates are up-to-date and accurate. As described above, expert rule templates each include a correlation probability, indicating a frequency of how often the effect parameter change threshold is satisfied when the cause change threshold is satisfied. At step 1430, at least one of the cause parameter, the cause change threshold, or the correlation probability of an expert rule template may be changed based on the updated historical data set.

Furthermore, method 1400 may be repeated when the historical data set is updated with subsequent data to identify a second correlated pair of different parameters of the updated historical data set. The second correlated pair of different parameters may be identified based on the repeated pairwise comparison of all parameters of the data set and the coincidence probability of the second correlated pair of different parameters, as described above for the initial correlated pair of different parameters.

FIGS. 15A-B show exemplary interfaces 1500 and 1550 showing insight graphic interfaces associated with a satisfied selected expert rule template according to one or more embodiments of the disclosure. Interface 1550 may be displayed to the user in response to selection of the populated natural language template 1510 in some embodiments. As shown, text narrative 1555 and visualization 1560 of the change in the effect parameter CPM over the predetermined time period of a month may be displayed explaining the cause-effect relationship. Furthermore, links 1565 and 1575 are provided to additional insight graphic interfaces that are related to the interface 1550. What happens when the links 1565 and 1575 are selected is highlighted in further detail below.

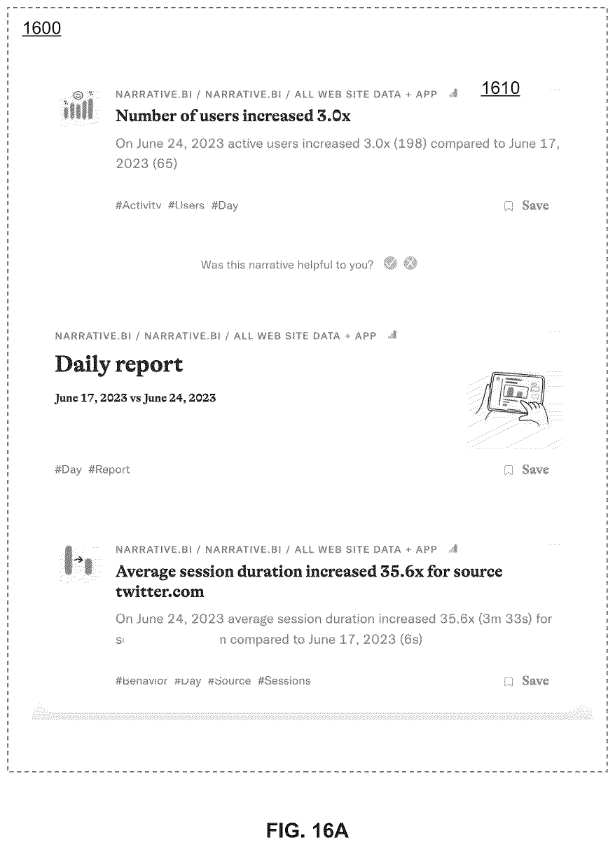

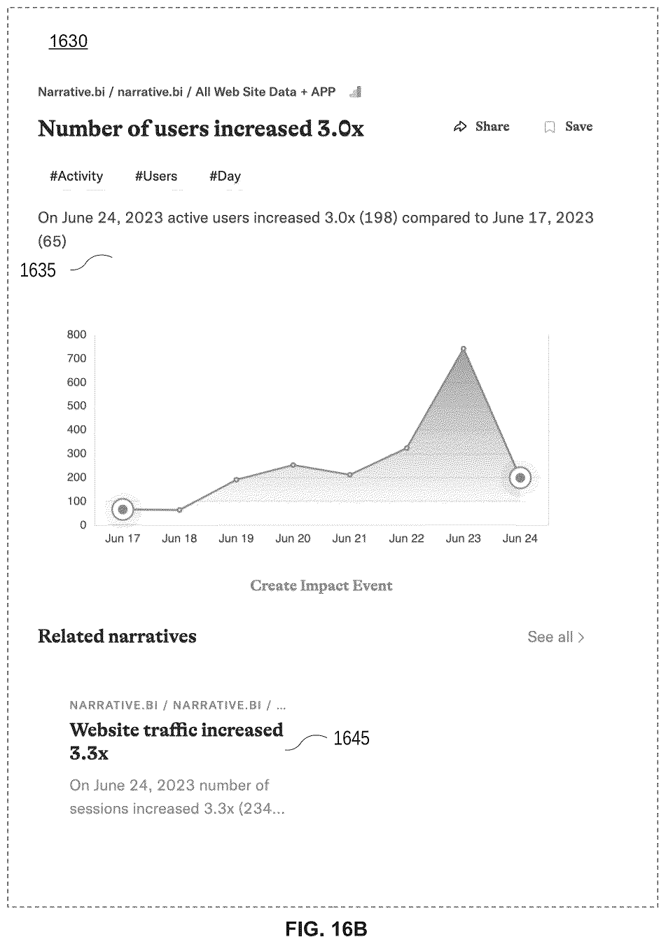

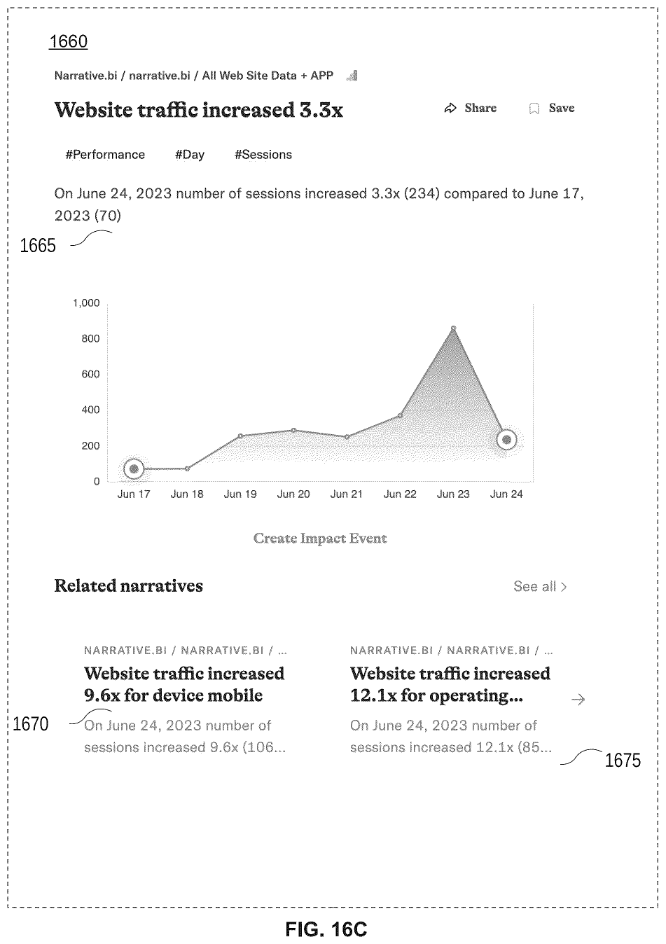

FIGS. 16A-C show exemplary interfaces showing insight graphic interfaces associated with satisfied selected expert rule templates having common cause parameters according to one or more embodiments of the disclosure. Interface 1600 includes link 1610 to an insight graphic interface for a satisfied expert rule template. When link 1610 is selected, interface 1630 may be caused to be displayed on a display device. Insight graphic interface displays a narrative and visualization 1635 related to a web site traffic parameter from the underlying data set. Also displayed is a link 1645 to a different insight graphic interface that is presented because the link is to an insight graphic interface also related to web site traffic. When the link 1645 is selected, interface 1660 may be presented. As seen in interface 1660, web site traffic is an effect parameter in the underlying expert rule template, where by contrast site traffic was a cause parameter in the expert rule template associated with interface 1630. In addition to narrative 1665, additional links 1670 and 1675 are provided to additional insight graphic interfaces, allowing a user to traverse multiple related cause-effect relationships to drill down as far as desired in the chain of causality.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method comprising:
extracting, by a server, event data objects from a stream of input data received over a network connection, each event data object comprising a parameter from a data set and a numerical trend over a predetermined period of time;
retrieving, by the server via a rule engine module, a plurality of selected expert rule templates from an expert rule database, the selected expert rule templates being selected based on having input parameters that match the parameters of one or more of the event data objects, each expert rule template stored within the expert rule database including a cause parameter from the data set, an effect parameter from the data set, change thresholds for both the cause and the effect parameters and time intervals for both the cause and effect parameters;
identifying, by the server, cause-effect relationships between parameters of the data set in response to the selected expert rule templates being satisfied by the extracted event data objects;
transmitting, by the server via the network connection, narrative text and one or more visualizations associated with a satisfied selected expert rule template to a display device;
causing, by the server, an insight graphic interface to be displayed by the display device, the insight graphic interface including the narrative text and the one or more visualizations;
identifying, by the server via a statistical correlation module, a correlated pair of different parameters of the data set observed over a plurality of predetermined correlation time periods, the correlated pair being identified based on pairwise comparison of all parameters of the data set and a coincidence probability of the different parameters;
creating, by the server, a new expert rule template in the expert rule database based on the correlated pair of different parameters between the different parameters; and
generating an alert, by the server, in response to one of the expert rule templates in the expert rule database or the new expert rule template being contradicted by subsequent data in the stream of input data.

2. The method of claim 1, the creating the new expert rule template in the expert rule database comprising:
causing a rule candidate interface to be displayed in response to the coincidence probability of the correlation exceeding a predetermined threshold, the rule candidate interface including the different parameters and proposed change thresholds for the different parameters; and
adding the new expert rule template to the expert rule database in response to receiving a user input received from the rule candidate interface.

3. The method of claim 1, where each expert rule template stored further includes a dimension constraint, an external factors field, a time lag field, and a correlation strength field.

4. The method of claim 1, the correlated pair of different parameters being identified based on a consistency coefficient that is a probability of when the different parameters each change by a respective change threshold over a single correlation time period, the consistency coefficient being determined for the different parameters over the plurality of predetermined correlation time periods.

5. The method of claim 1, further comprising:
adding, by the server, the subsequent data in the stream of input data to a data storage structure that stores data from the data set over the plurality of predetermined time periods to create an updated historical data set; and
repeating, via the statistical correlation module, the pairwise comparison of all the parameters of the data set and determining the persistence probabilities of pairs of the different parameters to identify a contradiction of the one of the expert rule templates within the data of the updated historical data set, the contradiction being satisfaction of only one of a change threshold a cause parameter and an effect parameter over a time interval of the one of the expert rule templates, the alert being generated in response to identification of the contradiction.

6. The method of claim 5, the adding the subsequent data to the data storage structure being triggered in response to receiving, by the server, the subsequent data in the stream of input data.

7. The method of claim 5, further comprising identifying, via the statistical correlation module, a second correlated pair of different parameters of the updated historical data set, the second correlated pair of different parameters being identified based on the repeated pairwise comparison of all parameters of the data set and the coincidence probability of the second correlated pair of different parameters.

8. The method of claim 5, where each expert rule template further includes a correlation probability indicating a frequency of how often the effect parameter change threshold is satisfied when the cause change threshold is satisfied, the method further comprising updating at least one of the cause parameter, the cause change threshold, or the correlation probability based on the updated historical data set.

9. The method of claim 1, where one of the selected expert rule templates is satisfied by the extracted event data objects when both the cause parameter change threshold and the effect parameter change threshold are met or exceeded by the extracted event data objects within a single time interval.

10. The method of claim 1, the pairwise comparison of all parameters of the data set being performed by:
generating a set of all possible pairs of parameters in the data set and a change direction of each parameter;
determining a coincidence probability of the pairs of parameters to have the change direction associated with each pair of parameters;
identify pairs from the set of all possible pairs of parameters having a greatest coincidence probability; and
filtering the identified pairs using a predetermined threshold, the correlated pair of different parameters being selected from the filtered pairs of parameters.

11. The method of claim 1, further comprising aggregating the data set from a plurality of sources having different structures and/or formats.

12. The method of claim 1, further comprising receiving feedback from users, the feedback being used to determine if the one of the expert rule templates in the expert rule database or the new expert rule template is contradicted by the subsequent data.

13. The method of claim 1, the insight graphic interface further including user-selectable links to different insight graphic interfaces that include a common cause parameter or effect parameter with the satisfied selected expert rule template.

14. A system comprising:
one or more processors; and
a non-transitory computer-readable medium storing a plurality of instructions, which when executed, cause the one or more processors to:
extract event data objects from a stream of input data received over a network connection, each event data object comprising a parameter from a data set and a numerical trend over a predetermined period of time;
retrieve a plurality of selected expert rule templates from an expert rule database, the selected expert rule templates being selected based on having input parameters that match the parameters of one or more of the event data objects, each expert rule template stored within the expert rule database including a cause parameter from the data set, an effect parameter from the data set, change thresholds for both the cause and the effect parameters and time intervals for both the cause and effect parameters;
identify cause-effect relationships between parameters of the data set in response to the selected expert rule templates being satisfied by the extracted event data objects; transmit, via the network connection, narrative text and one or more visualizations associated with a satisfied selected expert rule template to a display device;
cause an insight graphic interface to be displayed by the display device, the insight graphic interface including the narrative text and the one or more visualizations;
identify a correlated pair of different parameters of the data set observed over a plurality of predetermined correlation time periods, the correlated pair being identified based on pairwise comparison of all parameters of the data set and a coincidence probability of the different parameters;
create a new expert rule template in the expert rule database based on the correlated pair of different parameters between the different parameters; and
generate an alert in response to one of the expert rule templates in the expert rule database or the new expert rule template being contradicted by subsequent data in the stream of input data.

15. The system of claim 14, the creating the new expert rule template in the expert rule database comprising:
causing a rule candidate interface to be displayed in response to the coincidence probability of the correlation exceeding a predetermined threshold, the rule candidate interface including the different parameters and proposed change thresholds for the different parameters; and
adding the new expert rule template to the expert rule database in response to receiving a user input received from the rule candidate interface.

16. The system of claim 14, the correlated pair of different parameters being identified based on a consistency coefficient that is a probability of when the different parameters each change by a respective change threshold over a single correlation time period, the consistency coefficient being determined for the different parameters over the plurality of predetermined correlation time periods.

17. The system of claim 14, the plurality of instructions further causing the one or more processors to:
add the subsequent data in the stream of input data to a data storage structure that stores data from the data set over the plurality of predetermined time periods to create an updated historical data set; and
repeat the pairwise comparison of all the parameters of the data set and determining the persistence probabilities of pairs of the different parameters to identify a contradiction of the one of the expert rule templates within the data of the updated historical data set, the contradiction being satisfaction of only one of a change threshold a cause parameter and an effect parameter over a time interval of the one of the expert rule templates, the alert being generated in response to identification of the contradiction.

18. A non-transitory computer readable storage medium having embodied thereon a program, the program being executable by a processor for performing a method comprising:
extracting event data objects from a stream of input data received over a network connection, each event data object comprising a parameter from a data set and a numerical trend over a predetermined period of time;
retrieving, via a rule engine module, a plurality of selected expert rule templates from an expert rule database, the selected expert rule templates being selected based on having input parameters that match the parameters of one or more of the event data objects, each expert rule template stored within the expert rule database including a cause parameter from the data set, an effect parameter from the data set, change thresholds for both the cause and the effect parameters and time intervals for both the cause and effect parameters;
identifying cause-effect relationships between parameters of the data set in response to the selected expert rule templates being satisfied by the extracted event data objects;
transmitting, via the network connection, narrative text and one or more visualizations associated with a satisfied selected expert rule template to a display device;
causing an insight graphic interface to be displayed by the display device, the insight graphic interface including the narrative text and the one or more visualizations;
identifying, via a statistical correlation module, a correlated pair of different parameters of the data set observed over a plurality of predetermined correlation time periods, the correlated pair being identified based on pairwise comparison of all parameters of the data set and a persistence probability of the different parameters;
creating a new expert rule template in the expert rule database based on the correlated pair of different parameters between the different parameters; and
generating an alert in response to one of the expert rule templates in the expert rule database or the new expert rule template being contradicted by subsequent data in the stream of input data.

19. The non-transitory computer readable storage medium of claim 13, where the narrative text integrates the rule inputs into the text in an explanation of the text recommendation.

20. The non-transitory computer readable storage medium of claim 18, the creating the new expert rule template in the expert rule database comprising:
causing a rule candidate interface to be displayed in response to the coincidence probability of the correlation exceeding a predetermined threshold, the rule candidate interface including the different parameters and proposed change thresholds for the different parameters; and
adding the new expert rule template to the expert rule database in response to receiving a user input received from the rule candidate interface.

21. The non-transitory computer readable storage medium of claim 18, the correlated pair of different parameters being identified based on a consistency coefficient that is a probability of when the different parameters each change by a respective change threshold over a single correlation time period, the consistency coefficient being determined for the different parameters over the plurality of predetermined correlation time periods.
